(19) United States
(12) Patent Application Publication
(10) Pub. No.: US 2023/0060178 A1
(43) Pub. Date: Mar. 2, 2023

(54) ORGANOBORANE STRATEGY FOR POLYMERS BEARING LACTONE, ESTER, AND ALCOHOL FUNCTIONALITY

(71) Applicant: The Johns Hopkins University, Baltimore, MD (US)

(72) Inventors: Rebekka Klausen, Baltimore, MD (US); Yuyang Ji, Baltimroe, MD (US)

(21) Appl. No.: 17/781,455

(22) PCT Filed: Dec. 2, 2020
(86) PCT No.: PCT/US2020/062866

§ 371 Date: Jun. 1, 2022

Related U.S. Application Data
(60) Provisional application No. 62/942,253, filed on Dec. 2, 2019.

(51) Int. Cl. C08F 130/06; C08F 230/06; C08F 212/32; C08F 212/10

(52) U.S. Cl. CPC C08F 130/06; C08F 230/065; C08F 212/32; C08F 212/10

(57) ABSTRACT

Described are methods using aromatic vinyl borane monomers for the preparation of highly functionalized copolymers bearing vinyl alcohol, lactone, and ester side chains.

### CROSS-REFERENCE TO RELATED APPLICATION

The present invention claims the priority benefit of U.S. Provisional Patent Application No. 62/942,253, filed Dec. 2, 2019, which is incorporated herein by reference in its entirety.

### STATEMENT OF GOVERNMENTAL INTEREST

This invention was made with government support under grant no. CHE-1752791 awarded by the National Science Foundation. The government has certain rights in the invention.

### BACKGROUND

The incorporation of polar functional groups impacts a polymer's physical properties and applications. Franssen et al., 2013; Nakamura et al., 2009. The hydroxyl functional group (—OH) influences multiple properties. For example, hydroxyl-functionalized polyethylene has enhanced barrier properties against water and oxygen and the ethylene-vinyl alcohol copolymer (EVOH) is used in food packaging. Mokwena and Tang, 2012. Hydroxyl-functionalization also imparts increased solubility in polar solvents, improved adhesion to polar surfaces, and influences hydrogen-bonding, Nagara et al., 2001, with downstream effects on crystallinity, assembly, and phase transitions.

Vinyl acetate (VAc) is the traditional precursor to poly(vinyl alcohol) (PVA) and hydroxyl-functionalized copolymers by alkaline hydrolysis, Hallensleben et al., 2015, but this monomer poses significant synthetic challenges. The Lewis basic ester functional group is poorly compatible with early transition metal olefin polymerization catalysts. Ito et al., 2009. The propensity of the VAc-derived radical to undergo chain transfer and termination events is a challenge for controlled polymerization techniques like atom transfer radical polymerization (ATRP). Wakioka et al., 2002; Liao et al., 2013. Further, VAc exhibits poor copolymerization behavior with conjugated monomers like styrene (St), methyl acrylate (MA), and methyl methacrylate (MMA). Mayo et al., 1948(a); Mayo et al., 1948(b).

### SUMMARY

In some aspects, the presently disclosed subject matter provides a method for preparing a compound of formula (I) or formula (II);

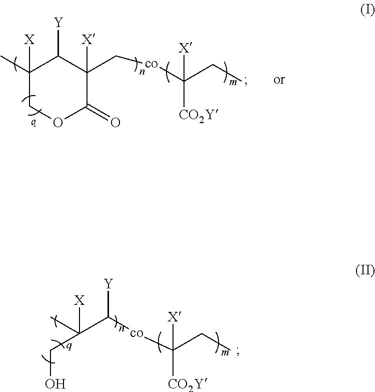

wherein:

each q is independently an integer selected from the group consisting of 0, 2, 3, 4, 5, 6, 7, and 8;

each n is independently an integer from 1 to 500;

each m is independently an integer from 1 to 1000;

X and X′ are each independently hydrogen or methyl;

Y is a hydrogen or an isobutyl group;

Y′ is selected from the group consisting of hydrogen, C₁-C ₁₂ straightchain or branched alkyl, chloroalkyl, hydroxyalkyl, (dimethylamino)alkyl, (diethylamino)alkyl, cycloalkyl, phenyl, benzyl, and naphthyl; or a stereoisomer thereof;

the method comprising:

(a) contacting BN 2-vinylnaphthalene (BN2VN), or a derivative thereof, with methyl methacrylate (MMA), or a derivative thereof, in the presence of an initiator to form a first intermediate; and

(b) oxidizing the first intermediate to form a compound of formula (I) or formula (II).

In some aspects, the BN 2-vinylnaphthalene (BN2VN), or a derivative thereof, has the following formula:

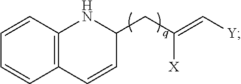

wherein:

X is a hydrogen or a methyl group;

Y is a hydrogen or an isobutyl group;

q is an integer selected from the group consisting of 0, 2, 3, 4, 5, 6, 7, and 8;
or a stereoisomer thereof.

In some aspects, MMA or a derivative thereof has the following formula:

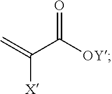

wherein:

X′ is a hydrogen or a methyl group;

Y′ is selected from the group consisting of hydrogen, C₁-C₁₂ straightchain or branched alkyl, chloroalkyl, hydroxyalkyl, (dimethylamino)alkyl, (diethylamino)alkyl, cycloalkyl, phenyl, benzyl, and naphthyl; or a stereoisomer thereof; or a stereoisomer thereof.

In some aspects, the initiator comprises 2,2-azobis(2-methylpropionitrile) (AIBN).

In some aspects, the first intermediate comprises:

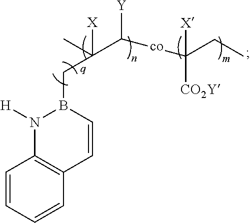

wherein:
q is an integer selected from the group consisting of 0, 2, 3, 4, 5, 6, 7, and 8;
n is an integer from 1 to 500;
m is an integer from 1 to 1000;
X and X′ are each independently hydrogen or methyl;
Y is a hydrogen or an isobutyl group;
Y′ is selected from the group consisting of hydrogen, C₁-C₁₂ straightchain or branched alkyl, chloroalkyl, hydroxyalkyl, (dimethylamino)alkyl, (diethylamino)alkyl, cycloalkyl, phenyl, benzyl, and naphthyl;
or a stereoisomer thereof.

In some aspects, the first intermediate is:

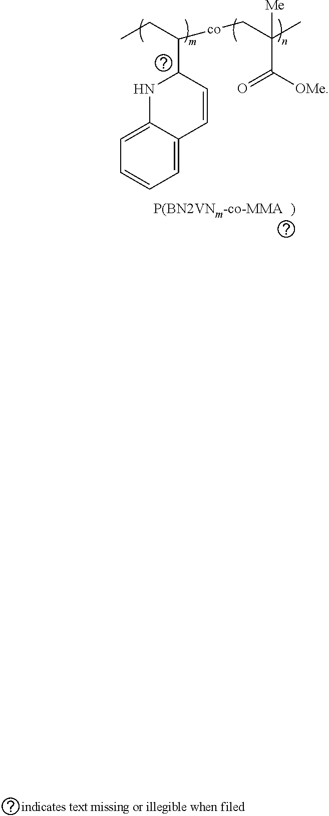

In some aspects, the oxidizing step comprises contacting the first intermediate with Me₃NO.2H₂O and cyclopentyl methyl ether (CPME).

In some aspects, the compound of formula (I) comprises:

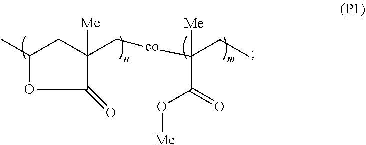

wherein n is an integer from 1 to 500 and m is an integer from 1 to 1000.

In some aspects, the compound of formula (II) comprises:

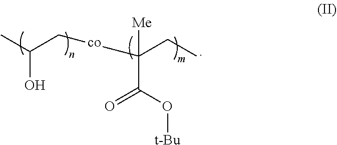

In some aspects, the method further comprises contacting the compound of formula (I):

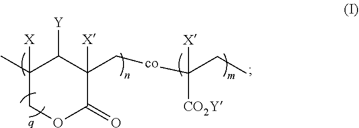

with a base to form a compound of formula (III):

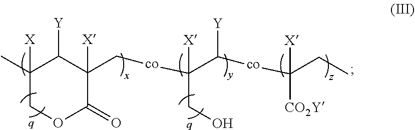

wherein:
each q is an integer selected from the group consisting of 0, 2, 3, 4, 5, 6, 7, and 8;
x is an integer from 1 to 500;
y is an integer from 1 to 1000;
z is an integer from 1 to 1000;
X and X′ are each independently hydrogen or methyl;
Y is a hydrogen or an isobutyl group;
Y′ is selected from the group consisting of hydrogen, C₁-C₁₂ straightchain or branched alkyl, chloroalkyl, hydroxyalkyl, (dimethylamino)alkyl, (diethylamino)alkyl, cycloalkyl, phenyl, benzyl, and naphthyl; or a stereoisomer thereof.

In some aspects, the base comprises NaOMe.

In some aspects, the compound of formula (III) is:

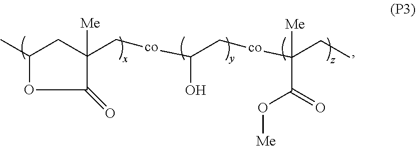

wherein x is an integer from 1 to 500, y is an integer from 1 to 1000 and z is an integer from 1 to 1000; or a stereoisomer thereof.

In some aspects, the presently disclosed subject matter provides a compound of formula (III):

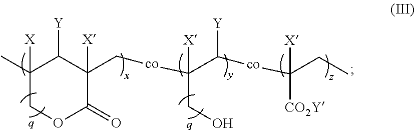

wherein:
q is an integer selected from the group consisting of 0, 2, 3, 4, 5, 6, 7, and 8;
x is an integer from 1 to 500;
y is an integer from 1 to 1000;
z is an integer from 1 to 1000;
X and X′ are each independently hydrogen or methyl;
Y is a hydrogen or an isobutyl group;
Y′ is selected from the group consisting of hydrogen, C₁-C₁₂ straightchain or branched alkyl, chloroalkyl, hydroxyalkyl, (dimethylamino)alkyl, (diethylamino)alkyl, cycloalkyl, phenyl, benzyl, and naphthyl; or a stereoisomer thereof.

In some aspects, the compound of formula (III) is:

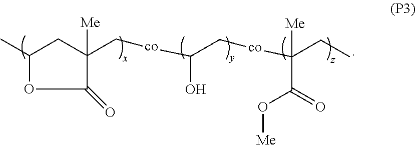

wherein x is an integer from 1 to 500, y is an integer from 1 to 1000 and z is an integer from 1 to 1000; or a stereoisomer thereof.

In some aspects, the presently disclosed subject matter provides a compound of formula (I):

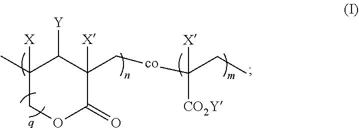

q is an integer selected from the group consisting of 0, 2, 3, 4, 5, 6, 7, and 8;

n is an integer from 1 to 500;

m is an integer from 1 to 1000;

X and X′ are each independently hydrogen or methyl;

Y is a hydrogen or an isobutyl group;

Y′ is selected from the group consisting of hydrogen, C₁-C₁₂ straightchain or branched alkyl, chloroalkyl, hydroxyalkyl, (dimethylamino)alkyl, (diethylamino)alkyl, cycloalkyl, phenyl, benzyl, and naphthyl; or a stereoisomer thereof.

In some aspects, the presently disclosed subject matter provides a compound of formula (II):

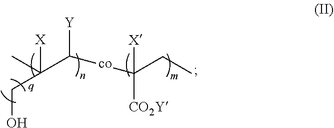

wherein:

q is an integer selected from the group consisting of 0, 2, 3, 4, 5, 6, 7, and 8;

n is an integer from 1 to 500;

m is an integer from 1 to 1000;

X and X′ are each independently hydrogen or methyl;

Y is a hydrogen or an isobutyl group;

Y′ is selected from the group consisting of hydrogen, C₁-C₁₂ straightchain or branched alkyl, chloroalkyl, hydroxyalkyl, (dimethylamino)alkyl, (diethylamino)alkyl, cycloalkyl, phenyl, benzyl, and naphthyl; or a stereoisomer thereof.

In some aspects, the presently disclosed subject matter provides a compound of the formula:

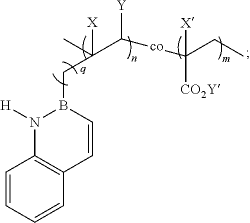

wherein:
q is an integer selected from the group consisting of 0, 2, 3, 4, 5, 6, 7, and 8;
n is an integer from 1 to 500;
m is an integer from 1 to 1000;
X and X′ are each independently hydrogen or methyl;
Y is a hydrogen or an isobutyl group;
Y′ is selected from the group consisting of hydrogen, C₁-C₁₂ straightchain or branched alkyl, chloroalkyl, hydroxyalkyl, (dimethylamino)alkyl, (diethylamino)alkyl, cycloalkyl, phenyl, benzyl, and naphthyl;
or a stereoisomer thereof.

Certain aspects of the presently disclosed subject matter having been stated hereinabove, which are addressed in whole or in part by the presently disclosed subject matter, other aspects will become evident as the description proceeds when taken in connection with the accompanying Examples and Figures as best described herein below.

### BRIEF DESCRIPTION OF THE FIGURES

The patent or application file contains at least one drawing executed in color. Copies of this patent or patent application publication with color drawing(s) will be provided by the Office upon request and payment of the necessary fee.

Having thus described the presently disclosed subject matter in general terms, reference will now be made to the accompanying Figures, which are not necessarily drawn to scale, and wherein:

FIG. 1A and FIG. 1B show FTIR spectra of: (FIG. 1A) comparison of PBN2VN and copolymer, showing presence of an NH and aromatic CH stretches; (FIG. 1B) comparison of PMMA and copolymer, showing presence of a carbonyl stretch;

FIG. 2A and FIG. 2B are: (FIG. 2A) ¹H NMR spectra (400 MHz, CD2Cl₂) of (top to bottom) PBN2VN, PBN2VN₃₀-co-PMMA₁₃₈, and PMMA; and (FIG. 2B) ¹³C NMR spectra of (top to bottom) PBN2VN, PBN2VN₃₀-co-PMMA₁₃₈, and PMMA;

FIG. 3A and FIG. 3B are cropped FTIR spectra of PBN2VN₃₀-co-PMMA₁₃₈ before and after Me₃NO/CPME oxidation. (FIG. 3A) the BN naphthalene ν(NH) diminished, but PVA ν(OH) was not apparent. (FIG. 3B) The ν(C═O)_{MMA} was retained after oxidation and a second ν(C═O) band at 1771 cm⁻¹ was observed;

FIG. 4 is a comparison of carbonyl stretching region in oxidized PBN2VN₃₀-co-PMMA₁₃₈ (P1, black) and commercial samples of γ-butyrolactone (γ-BL, red) and poly(acrylic acid) (PAA, blue). The agreement between the γ-BL carbonyl stretch and the new band in P1 is highlighted with a vertical dashed line. The putative structure of P1 is shown;

FIG. 5A, FIG. 5B, and FIG. 5C show: (FIG. 5A) the lactone ν(CO) stretching frequency in smaller rings shifts to higher frequency. (FIG. 5B) only a head-to-tail arrangement of neighboring vinyl alcohol and methyl methacrylate residues gives rise to the five-membered γ-butyrolactone substructure. (FIG. 5C) the tail-to-tail isomer would give rise to a δ-valerolactone substructure. The formation of a β-propionitrile substructure from a head-to-head isomer is not shown;

FIG. 6A, FIG. 6B, FIG. 6C, and FIG. 6D show the steric influence on lactonization. (FIG. 6A) influence of alcohol steric parameters on alcoholysis rate. Brown and Keblys, 1966. (FIG. 6B) synthesis of BN2VN-tBMA copolymer and oxidation to P2. (FIG. 6C) cropped FTIR spectra of PBN2VN₄₁-co-PtBMA₁₅₁ (top) and P2 (bottom) showing a single ν(CO) band at 1710 cm⁻¹. No γ-butyrolactone peak at 1770 cm⁻¹ was observed. (FIG. 6D) Appearance of PVA methane (CH—OH) resonance in ¹H NMR spectrum of P2;

FIG. 7 shows the methanolysis of lactonized PVA-co-PMMA to P3. FTIR spectra before (top) and after (bottom) methanolysis (reflux in 0.5 M NaOMe/MeOH at 70° C. for 48 h). Spectra are labeled with putative structures. Inset shows ν(CO) region and diminishment of the 1770 cm⁻¹ lactone feature;

FIG. 8 shows images of PBN2VN₂₈-co-PMMA₂₁₀ (left) and PMMA (right). MMA=methyl methacrylate; AIBN=azoisobutyronitrile;

FIG. 9 shows UV-Vis Spectra of PBN2VN-PMMA blends. Polymer blends were made by mixing THF solutions of PBN2VN and PMMA ([homopolymer]=0.0272 g L−1) to yield the desired v/v ratios (Table 1). 10 mL and 50 mL volumetric flasks were used for accuracy;

FIG. 10 is a plot of ϵ320 vs. weight fraction (χ) of PBN2VN in PBN2VN-PMMA blends (see FIG. 9). The dashed line corresponds to a linear fit given by eq. S1. Copolymer ϵ320 values were fit to eq. S1 to determine weight % incorporation of BN2VN during free radical copolymerization. Mole percent incorporation of BN2VN could be converted from χ by eq. S2 (see Table 5).

FIG. 11 shows normalized GPC traces. Unimodal GPC traces are consistent with a single copolymer instead of two homopolymers;

FIG. 12 is stacked diffusion ordered spectroscopy (DOSY) Spectra (CD₂Cl_{2, 400} MHz) of BN2VN-MMA copolymers. The x-axis and y-axis are replaced by the spectra of P(BN2VN₃₀-co-MMA₁₃₈). DOSY spectra are consistent with a single copolymer, as opposed to two homopolymers;

FIG. 13 shows background subtracted ¹¹B NMR Spectrum (CD₂Cl₂, 128 MHz) of P(BN2VN₃₀-coMMA₁₃₈);

FIG. 14 shows the mechanism of Me₃NO-mediated oxidation of BN2VN copolymers;

FIG. 15 shows cropped ¹³C {¹H} NMR (101 MHz, CD₂Cl₂) spectra of P(BN2VN₃₀-co-MMA₁₃₈) and Oxy. P(BN2VN₃₀-co-MMA₁₃₈) (P1) focusing on the carbonyl region;

FIG. 16 shows ¹H NMR (400 MHz, CD₂Cl₂) Spectrum of P(BN2VN₄₁-co-tBMA₁₅₁); and

FIG. 17A and FIG. 17B show (FIG. 17A). DEPT 135 ¹³C NMR (101 MHz, CD2Cl²) spectrum of P2. (FIG. 17B). HSQC spectrum of P2. Correlation between methine proton and carbon resonance is indicated.

### DETAILED DESCRIPTION

The presently disclosed subject matter now will be described more fully hereinafter with reference to the accompanying Figures, in which some, but not all embodiments of the inventions are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Figures. Therefore, it is to be understood that the presently disclosed subject matter is not to be limited to the specific embodiments disclosed and that modifications and other embodiments are intended to be included within the scope of the appended claims.

### I. Organoborane Strategy for Polymers Bearing Lactone, Ester, and Alcohol Functionality

Vinyl alcohol—methacrylate copolymers have intriguing functionally rich structures, but are synthetically inaccessible from vinyl acetate, the traditional precursor to polyvinyl alcohol. BN 2-vinylnaphthalene (BN2VN), van de Wouw et al., 2017; van de Wouw et al., 2018(a); van de Wouw et al., 2018(b); Mendis et al., 2018; van de Wouw et al., 2019, is a recently reported PVA precursor with versatile reactivity arising from its aromatic structure (see Scheme 1). Bosdet and Piers, 2009; Campbell et al., 2012; Giustra and Liu, 2018.

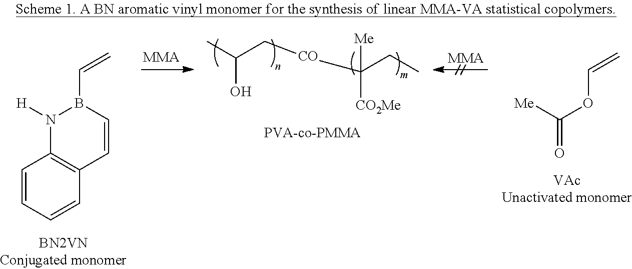

BN2VN is straightforwardly synthesized and multigram scale polymerization was reported. van de Wouw et al., 2017. It is compatible with titanium-based olefin polymerization catalysts that yield syndiotactic polymer. Mendis et al., 2018. BN2VN also readily copolymerizes with styrene under radical conditions. van de Wouw et al., 2018(a); van de Wouw et al., 2018. Nonlinear least-squares (NLLS) statistical analysis showed a dramatic narrowing of the styrene-BN2VN reactivity ratios compared to styrene-VAc (r₁(St)=2.3, r₂(BN2VN)=0.42; r₁(St)=55, r₂(VAc)=0.01). Mayo et al., 1948; van de Wouw et al., 2018(b).

The side chain C—B bond of BN2VN polymers is converted to a C—OH bond with alkaline hydrogen peroxide (H₂O₂/NaOH), which is effective for the synthesis of PVA-r-PS, van de Wouw et al., 2018(a), and syndiotactic PVA (sPVA), Mendis et al., 2018, from BN2VN-derived precursors. Ouchi recently described a similar approach to poly(α-methyl vinyl alcohol) via isopropenyl pinacol boronate polymerization. Ouchi and Nishikawa, 2019. Postpolymerization borylation, either by hydroboration of alkenyl residues. Chung et al., 1988; Chung et al., 1993; Herz et al., 2013; Tanaka et al., 2014, or CH activation, is a well-explored strategy for polyolefin functionalization. Kondo et al., 2002; Bae et al., 2005(a); Bae et al., 2005(b).

Like St-VA statistical copolymers, MMA-VA statistical copolymers are an elusive target for polymer synthesis. MMA and VAc have highly mismatched reactivity ratios (r₁(MMA)=20, r₂(VAc)=0.015). Significant excess of the vinyl ester is required for high degrees of incorporation. Wang et al., 2013. This fact, in combination with the challenge of achieving a high degree of selectivity in the hydrolysis of the vinyl acetate side chain in the presence of an acrylic side chain, Peixoto et al., 2011, complicates the preparation of MMA-VA copolymers from vinyl acetate.

BN2VN is a promising solution. Its conjugated structure is a better reactivity match with MMA. The extensive use of organoboranes in natural product synthesis provides a broad range of conditions for organoborane functionalization in organic solvents. In the context of BN2VN-MMA copolymer oxidation, the typical aqueous H₂O₂/NaOH oxidation conditions pose risks, such as side chain hydrolysis to poly(methacrylic acid) (PMAA) and the formation of acyloxy derivatives.

In some embodiments, the presently disclosed subject matter provides the statistical copolymerization of MMA and BN2VN, as well as the development of a mild oxidation procedure. Trimethylamine N-oxide (Me₃NO.2H₂O) in cyclopentyl mether ether (CPME) converts PMMA-co-PBN2VN to PMMA-co-PVA without methyl ester hydrolysis (Scheme 1). Kabalka and Hedgecock, 1975; Kabalka, 1977.

PMMA-co-PVA is not isolable: cyclization to give five-membered butyrolactone substructures is rapid and facile. The incorporation of lactone substructures so closely associated with a polyolefin backbone is unprecedented and may have important consequences for mechanical properties and further postfunctionalization. Lactonization is an equilibrium process and the vinyl alcohol residues are recovered by methanolysis. The stability of BN2VN-tert-butyl methacrylate (tBMA) copolymers also is demonstrated, which, without wishing to be bound to any one particular theory, can be attributed to the slower rate of lactonization with bulkier ester side chains.

Conventional free radical copolymerization of BN2VN and methyl methacrylate (MMA) is facile. Conversion of BN2VN side chains to VA side chains is accomplished in organic solvents with Me₃NO.2H₂O and avoids MMA hydrolysis. The VA-MMA copolymer rapidly lactonizes to give an unprecedented macromolecule bearing both acyclic and cyclic ester residues. Methanolysis furnishes the statistical copolymer bearing vinyl alcohol, methyl methacrylate, and lactone residues. tert-Butyl methacrylate-BN2VN copolymers were shown to not lactonize.

BN2VN-MMA Copolymerization. AIBN-initiated free radical copolymerization of MMA and BN2VN was performed at different molar ratios of the comonomers (10-50% BN2VN, Scheme 2).

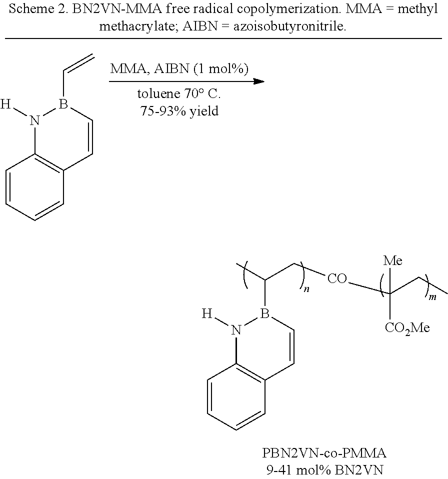

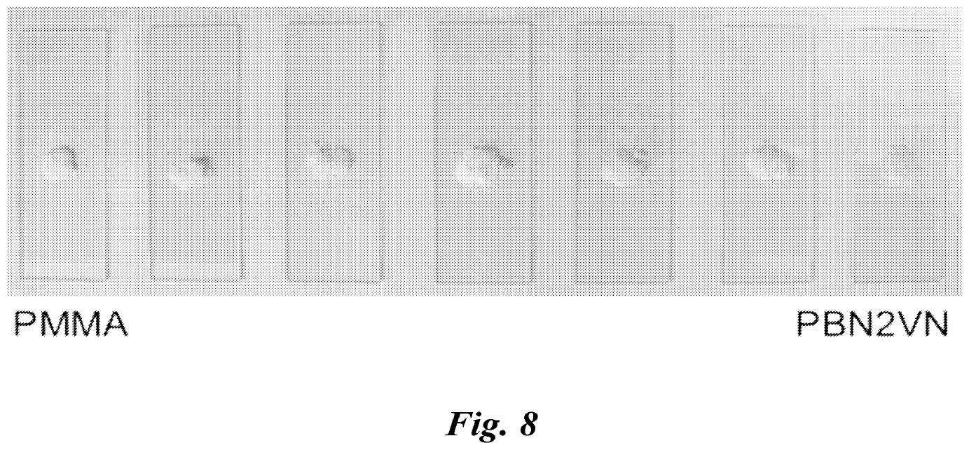

High yields were obtained in all cases after precipitation into methanol. The BN naphthalene chromophore absorbs strongly at 320 nm and PBN2VN is a yellow powder, while PMMA is white. The copolymers become increasingly yellow as the BN2VN content increases (FIG. 8). The unique absorption at 320 nm of the BN naphthalene chromophore facilitated quantitative determination of BN2VN content in BN2VN-2VN and BN2VN-St copolymers. van de Wouw et al., 2017; van de Wouw et al., 2018(a).

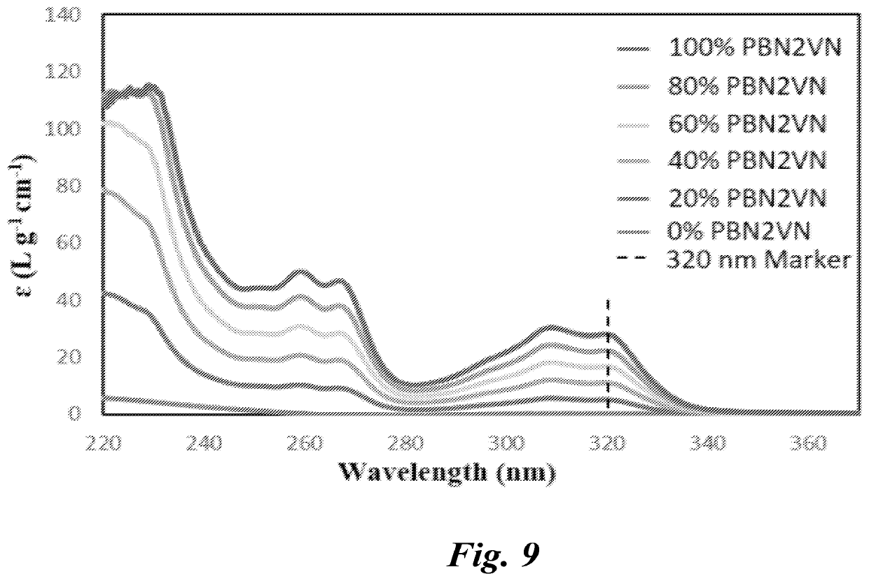

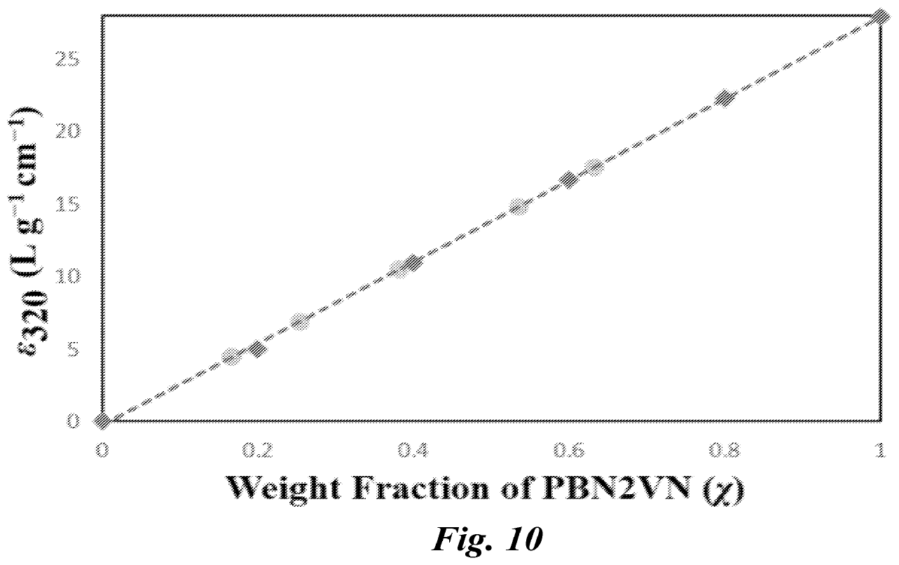

A similar assay was developed for BN2VN-MMA copolymers (FIG. 9 and FIG. 10), using the polymer blends provides in Table 1.

TABLE 1
Polymer blends.

| Entry | PMMA (wt. %) | PBN2VN (wt. %) |
|---|---|---|
| 1 | 100 | 0 |
| 2 | 80 | 20 |
| 3 | 60 | 40 |
| 4 | 40 | 60 |
| 5 | 20 | 80 |
| 6 | 0 | 100 |

Good agreement between mol % BN2VN in the feed compared to the copolymer was observed (Table 2).

TABLE 2
Copolymer optical properties and BN2VN incorporation.

| | Feed ratio | | Experimental | |
|---|---|---|---|---|
| | mol % | | mol % | Yield |
| Sample Name | BN2VN | ε₃₂₀ ^{a} | BN2VN ^{b} | (%) |
| PBN2VN₂₈-co-PMMA₂₁₀ | 10.0 | 4.5 | 11.5 | 80 |
| PBN2VN₃₀-co-PMMA₁₃₈ | 20.0 | 6.9 | 18.0 | 75 |
| PBN2VN₃₈-co-PMMA₉₄ | 30.0 | 10.5 | 28.5 | 83 |
| PBN2VN₄₀-co-PMMA₅₄ | 40.0 | 14.8 | 42.7 | 80 |
| PBN2VN₄₁-co-PMMA₃₇ | 50.0 | 17.5 | 52.7 | 93 |

^{a} In L g⁻¹ cm⁻¹.
^{b} Determined from ε₃₂₀.

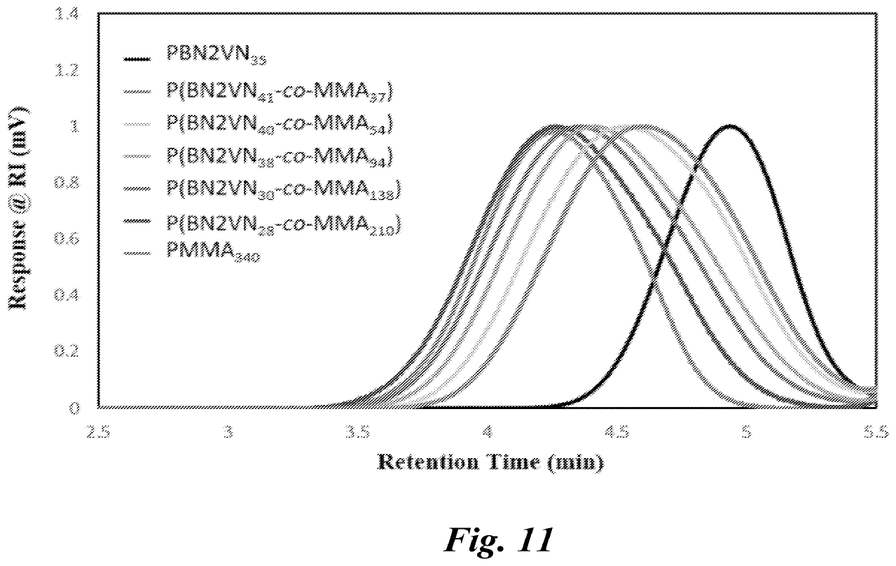

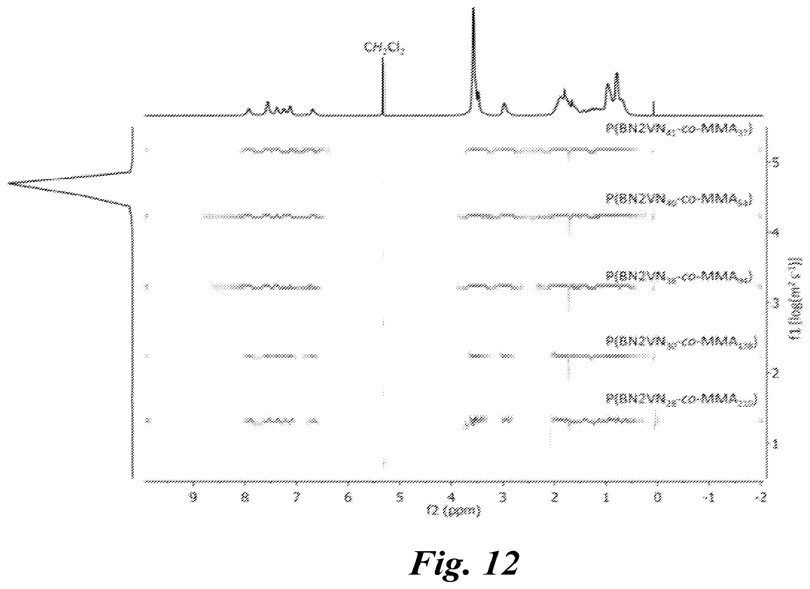

Copolymer molecular weight properties were determined by gel permeation chromatography (GPC) relative to a polystyrene standard and are summarized in Table 3. Unimodal molecular weight distributions were observed, supporting preparation of a copolymer instead of a mixture of two homopolymers (FIG. 11). Diffusion-oriented NMR spectroscopy (DOSY) also was consistent with a single copolymer (FIG. 12).

TABLE 3
Copolymer molecular weight properties.

| | Mₙ | |
|---|---|---|
| Sample Name | (kDa)^{a} | Ð |
| PBN2VN₂₈-co-PMMA₂₁₀ | 25.3 | 2.25 |
| PBN2VN₃₀-co-PMMA₁₃₈ | 18.5 | 2.46 |
| PBN2VN₃₈-co-PMMA₉₄ | 15.3 | 2.54 |
| PBN2VN₄₀-co-PMMA₅₄ | 11.6 | 2.53 |
| PBN2VN₄₁-co-PMMA₃₇ | 10.1 | 2.36 |

^{a}Determined by Gel Permeation Chromatography (GPC) analysis at RI relative to polystyrene standard (THF, 20 μL, 35 mL min⁻¹, 40° C.).

PBN2VN-co-PMMA Structural Characterization. The copolymers were structurally characterized by ¹H, ¹¹B, and ¹³C nuclear magnetic resonance (NMR) spectroscopy and Fourier transform infrared (FTIR) spectroscopy. All copolymers show resonances diagnostic of both BN2VN and MMA incorporation. Representative results for PBN2VN₃₀-co-PMMA₁₃₈ are provided herein.

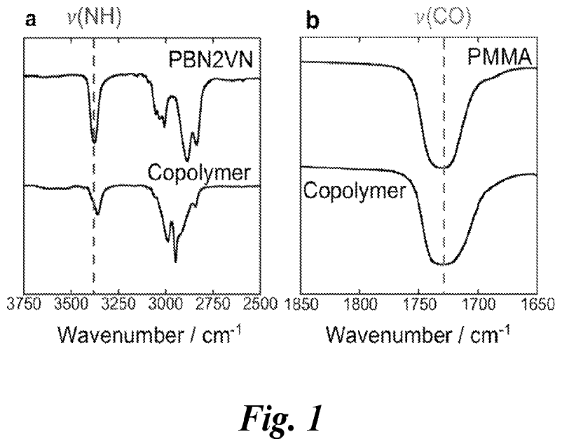

A distinctive FTIR spectroscopy feature of BN2VN incorporation is the presence of a sharp NH resonance at ca. 3375 cm⁻¹. This feature also was seen in the copolymers (FIG. 1A). Aromatic CH stretching frequencies>3000 cm⁻¹ were observed in both PBN2VN and PBN2VN₃₀-co-PMMA₁₃₈, as well. A sharp feature at 1727 cm⁻¹ was observed in both PMMA and PBN2VN₃₀-co-PMMA₁₃₈, and was assigned to the carbonyl stretch (FIG. 1B).

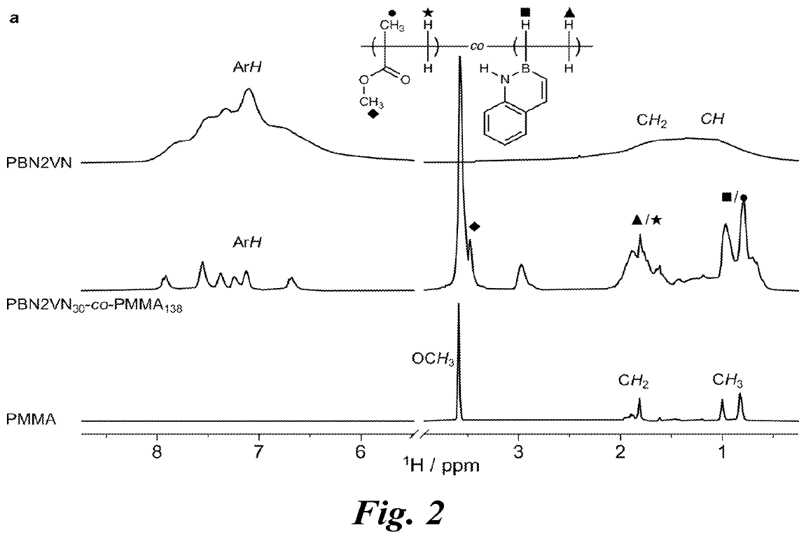

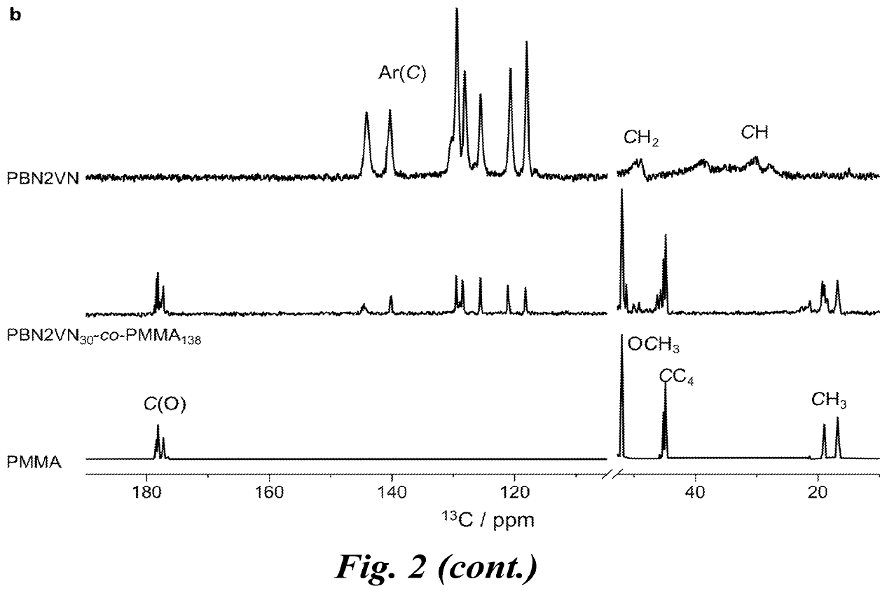

¹H, ¹¹B, and ¹³C NMR spectra of PBN2VN₃₀-co-PMMA₁₃₈ were recorded in methylene chloride-d2 at room temperature. The copolymer showed resonances consistent with both BN2VN and MMA incorporation. In the ¹NMR spectrum, six aromatic resonances consistent with the BN naphthalene side chain were observed (FIG. 2A). Sharp singlets (δ 3.58-3.48) were assigned to methoxy resonances from the ester side chain. Features at δ 1.81 and δ 0.80 were assigned to overlapping backbone resonances, including methylene, methane, and α-methyl groups from both BN2VN and MMA. The α-CH₃ resonance of PMMA resolves into mm, mr, and rr triads in chloroform-d and tacticity likely contributes to the spectrum of PBN2VN₃₀-co-PMMA₁₃₈, as well.

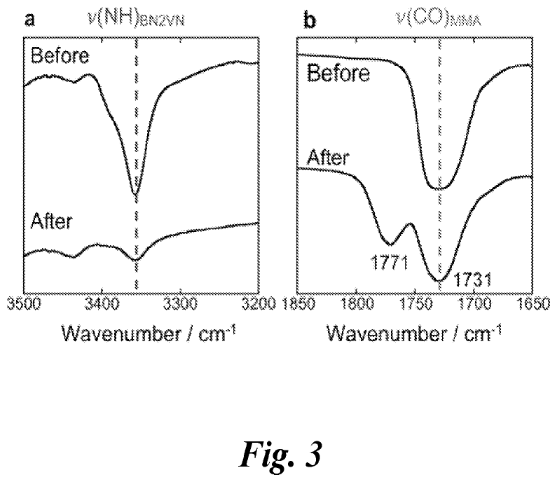

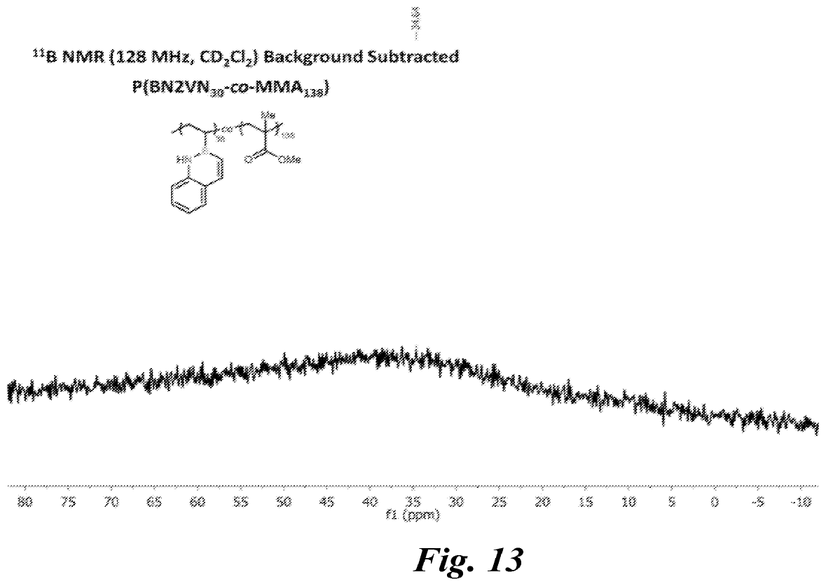

The ¹³C NMR spectrum of PBN2VN₃₀-co-PMMA₁₃₈ showed resonances consistent with both BN2VN and MMA incorporation (FIG. 2B). Carbonyl (δ 176-178) and aromatic (δ 118-144) resonances were readily identified (FIG. 3B). The quadrupolar boron-11 nucleus broadens the resonances of carbon atoms attached to boron, Wrackmeyer, 1979, and BN2VN backbone resonances were challenging to observe in the copolymer. The PMMA methoxy, methyl, and quaternary resonances, however, were identified. Finally, the ¹¹B NMR spectrum of PBN2VN₃₀-co-PMMA₁₃₈ showed a broad feature centered at δ 35 consistent with PBN2VN (δ 29) (FIG. 13). This resonance is comparable to other polymers derived from BN aromatic vinyl monomers. Lin et al., 2019; Wan et al., 2016; Thiedemann et al., 2017.

Oxidation. In considering the postpolymerization functionalization of BN2VN-MMA copolymers, aqueous conditions that could hydrolyze the MMA side chain were of concern. While Carpentier reported aqueous H₂O₂/NaOH oxidation of boron-functionalized poly(β-hydroxyalkanoate)s, the significant decrease in molecular weight and increase in dispersity after oxidation suggested partial cleavage of the polyester backbone. Ajellal et al., 2009.

Williams and coworkers recently reported the use of 9-BBN followed by meta-chloroperbenzoic acid (mCPBA) in THF for the hydroboration-oxidation of alternating polyesters and did not report evidence of chain scission. Yi et al., 2019. Hydroboration-oxidation resulted in alternating hydrophobic-hydrophilic side chains and nanostructured self-assemble. Organoboranes are versatile intermediates in organic synthesis and the literature on molecular organoboranes was reviewed for alternatives. Kabalka reported the use of Me₃NO.2H₂O as an organoborane oxidant that is compatible with a broad range of organic solvents and provides increased yields relative to H₂O₂/NaOH for highly functionalized molecules. Kabalka and Hedgecock, 1975; Kabalka, 1977. Me₃NO.2H₂O appeared particularly attractive as Me₃N is volatile, simplifying polymer isolation and purification.

Me₃NO-induced oxidation of BN2VN copolymers in cyclopentyl methyl ether (CPME), a high-boiling ethereal solvent that compatibilized all of the copolymers and Me₃NO.2H₂O, was investigated. For all five copolymers, we 85-92% conversion in 24 hours of the BN naphthalene side chain was observed based on UV-vis spectroscopy. Residual BN2VN also could be detected by NMR spectroscopy.

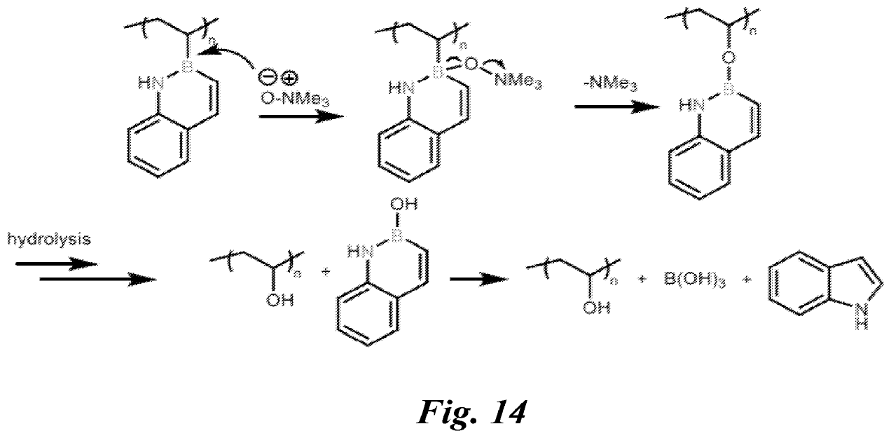

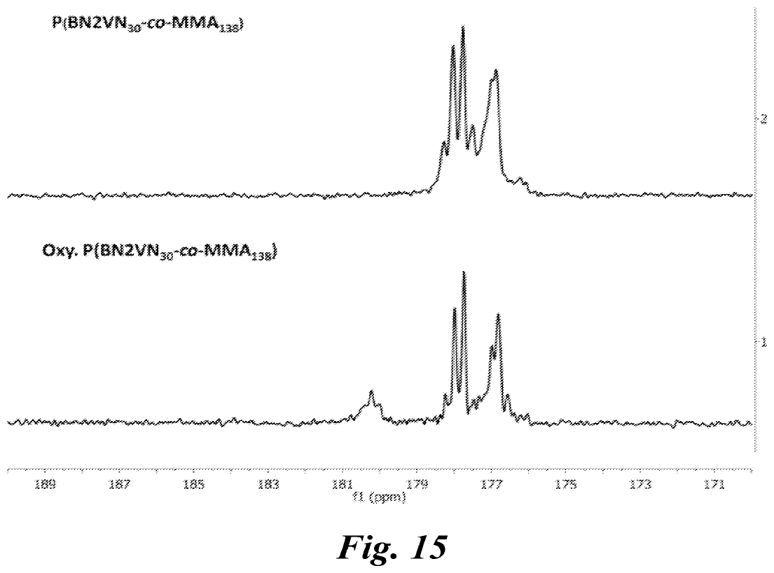

The byproducts of oxidation include boric acid (B(OH)₃), indole, and trimethylamine (NMe₃). Indole and B(OH)₃ arise from oxidation of the internal C—B bond of the initially formed BN naphthol and also were the byproducts observed in hydrogen peroxide-mediated oxidations (see FIG. 14 for the mechanism of Me₃NO-mediated oxidation of BN2VN copolymers). van de Wouw et al., 2018(a); Mendis et al., 2018.

TABLE 4
Oxidized copolymers: molecular weight properties.

| | Mₙ | M_{w}/ | Yield | Conversion |
|---|---|---|---|---|
| Polymer Name | (kDa) | Mₙ | (%) | (%) |
| Oxy. PBN2VN₂₈-co-PMMA₂₁₀ | 23.0 | 2.25 | 84 | 85 |
| Oxy. PBN2VN₃₀-co-PMMA₁₃₈ (P1) | 14.4 | 2.70 | 88 | 87 |
| Oxy. PBN2VN₃₈-co-PMMA₉₄ | 13.2 | 3.08 | 50 | 92 |
| Oxy. PBN2VN₄₀-co-PMMA₅₄ | 9.89 | 2.73 | 35 | 92 |
| Oxy. PBN2VN₄₁-co-PMMA₃₇ | 8.45 | 2.40 | 20 | 92 |

While signatures of oxidation were present, structural characterization was not consistent with PVA-co-PMMA. In the following discussion, spectra of oxidized PBN2VN₃₀-co-PMMA₁₃₈ (P1) are shown as a representative sample. Fourier transform infrared (FTIR) spectroscopy of P1 showed diminishment of the characteristic BN naphthalene ν(NH) after oxidation, but not hydroxyl stretching frequencies (ν(OH)) consistent with PVA (FIG. 3A). A low intensity feature at ca. 3450 cm⁻¹ was observed both before and after oxidation and likely corresponds to the overtone of ν(CO_{MMA}. Sutandar et al., 1994.

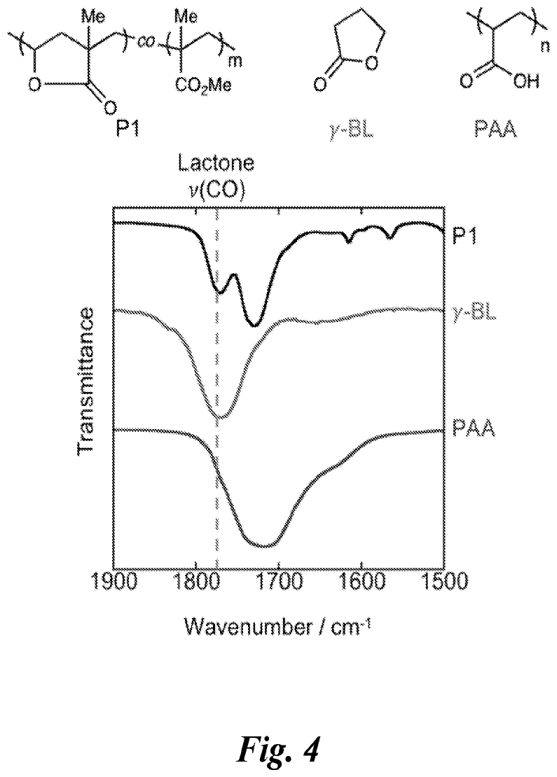

More insight arose from considering the carbonyl region of the FTIR spectrum. The ν(CO)_{MMA} was preserved at 1731 cm⁻¹, but an additional band was observed at 1771 cm⁻¹(FIG. 3B). The additional carbonyl stretching frequency is very similar to the carbonyl stretch of γ-butyrolactone (1770 cm⁻¹, FIG. 4). The possible hydrolysis of the methyl ester side chain to a carboxylic acid also was considered, but poor agreement was observed between the FTIR spectrum of oxidized PBN2VN₃₀-co-PMMA₁₃₈ and poly(acrylic acid) (FIG. 4).

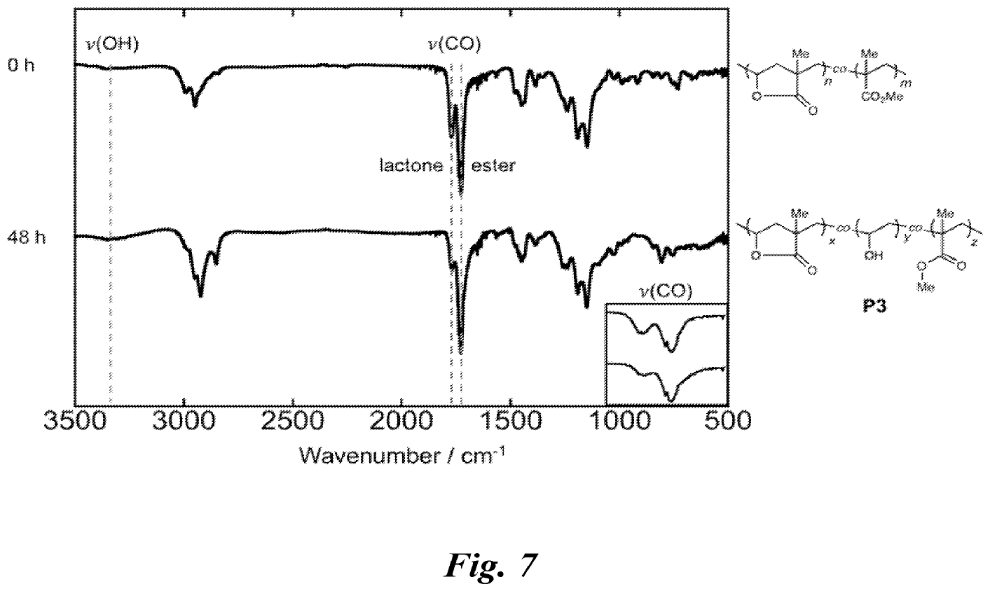

Based on the preservation of the methyl ester feature, the appearance of a new band diagnostic of a five-membered lactone, and the diminishment of hydroxyl resonances, without wishing to be bound to any one particular theory, it was thought that partial lactonization of PVA-co-PMMA occurred in CPME (Scheme 3). This hypothesis was supported by ¹³C NMR spectroscopic data that showed multiple carbonyl resonances (FIG. 7).

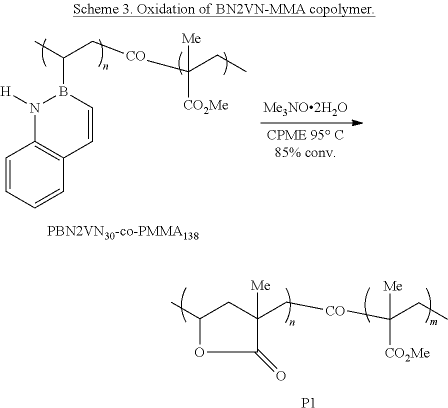

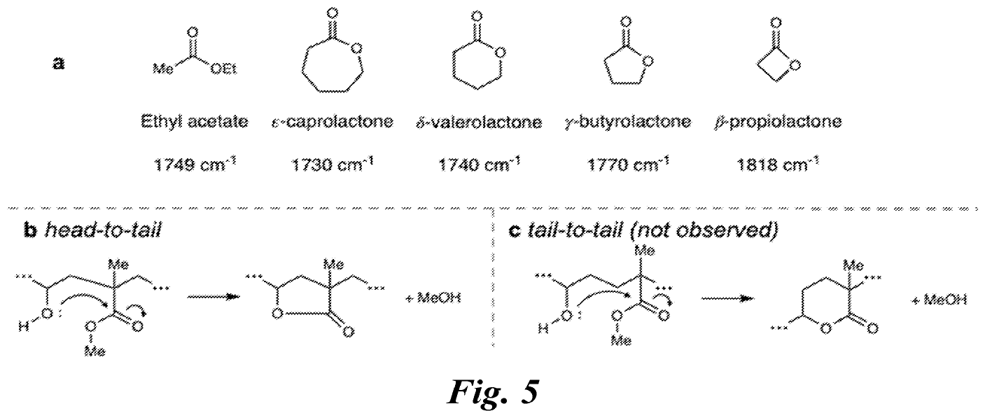

Microstructure and Mechanism of Lactonization. Ring strain induces characteristic shifts to higher frequency with decreasing ring size in lactones (FIG. 5). Hasha et al., 1991. The strong 1770 cm⁻¹ band observed in our experimental spectrum of P1 suggests the γ-buyrolactone substructure is dominant over any other lactone.

The FTIR spectroscopic data therefore provided revealing insights into polymer microstructure. The five-membered lactone substructure only arises from adjacent head-to-tail vinyl alcohol and methyl methacrylate monomers (FIG. 5B), while head-to-head and tail-to-tail arrangements would form smaller and larger rings respectively (FIG. 5C). Additionally, the intensity of the signal is more consistent with a statistical distribution of monomers along the macromolecular chain, as a blocky structure would result in one butyrolactone substructure per block junction.

Transesterification is an equilibrium process. While exchange can occur simply upon mixing, acid or base catalysis is typically employed for reasonable reaction rates. Otera, 1993. With respect to lactonization, the conversion of methyl 4-hydroxybuyrate to γ-butyrolactone is rapid and requires only trace acid. Brown and Keblys, 1966. Either the trimethylamine or boric acid byproducts of the oxidation reaction are sufficiently basic or acidic to catalyze lactonization of the initially formed VA-MMA statistical copolymer. While Me₃N might also be expected to buffer boric acid, Me₃N is also volatile.

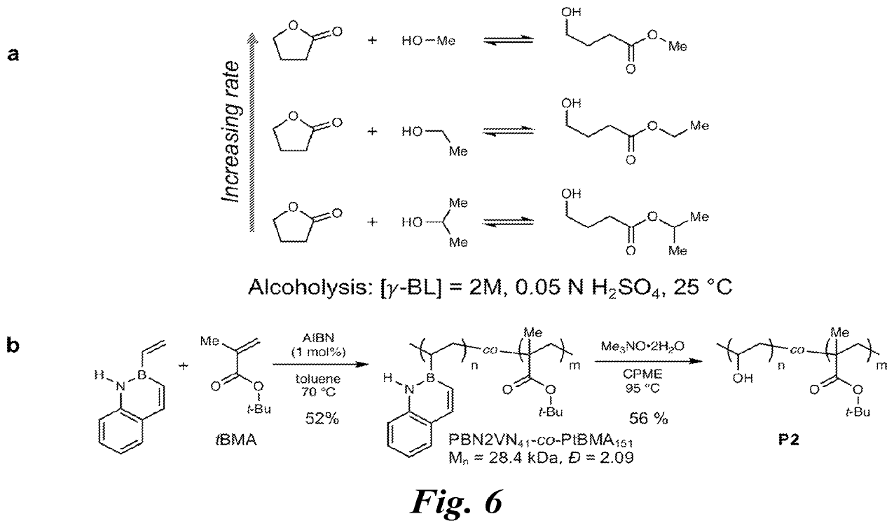

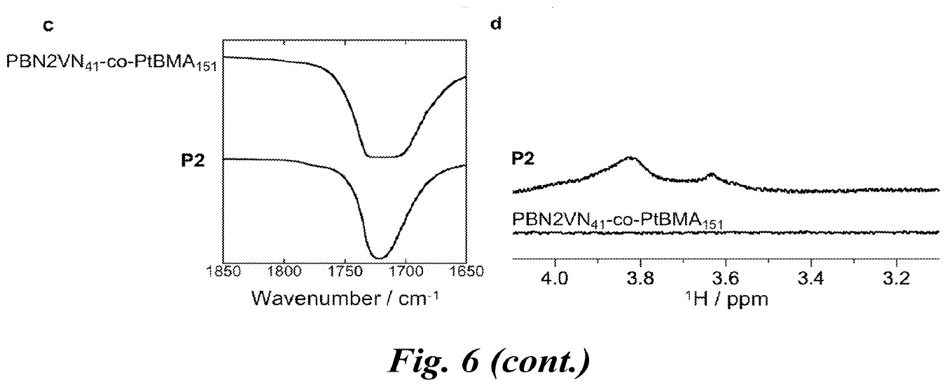

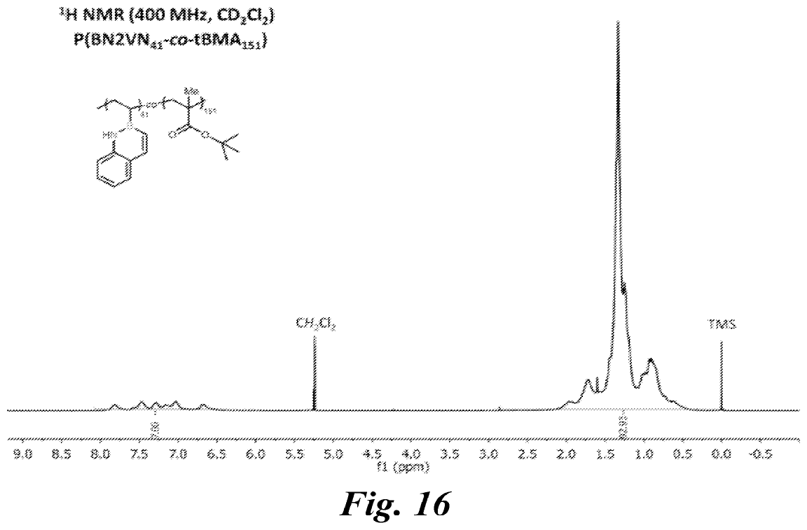

H. C. Brown studied the rate of γ-butyrolactone alcoholysis at room temperature with methanol, ethanol, and 2-propanol and observed a decrease in the rate of alcoholysis with increasing size of the alcohol (FIG. 6A). Brown and Keblys, 1966. The effect of alcohol size on the equilibrium constant is much less pronounced than the effect on rate. By the principle of microscopic reversibility, the rate of lactonization should also decrease with increasing bulk of the ester substituent. We therefore investigated the copolymerization of BN2VN and tert-butyl methacrylate (tBMA), as well as the Me₃NO-mediated oxidation (FIG. 6B). Free radical copolymerization of tBMA and BN2VN yielded a pale yellow polymer in reasonable yield (52%) and molecular weight (28.4 kDa). Comprehensive NMR spectroscopic characterization was consistent with incorporation of both monomers (FIG. 16). Oxidation under the typical conditions proceeded in 60% conversion and yielded P2 in 56% yield.

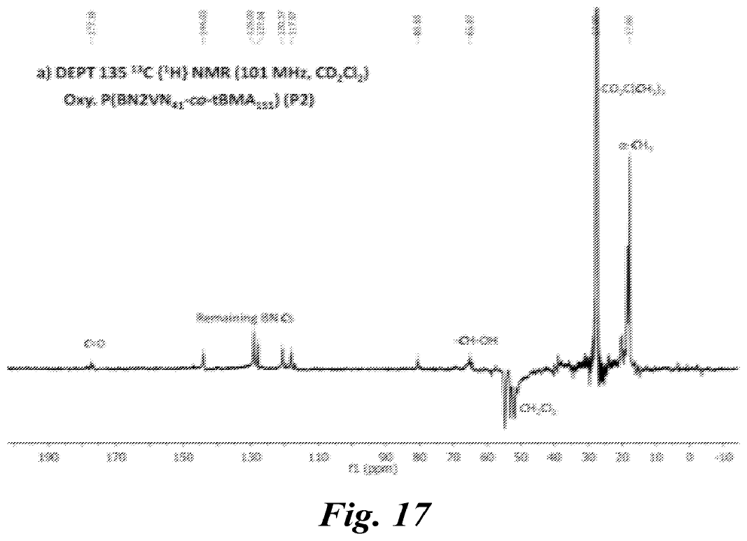

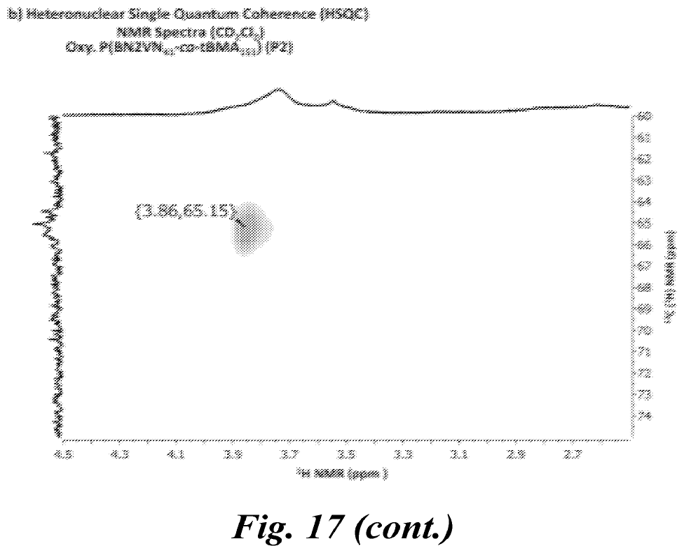

FTIR spectra of PBN2VN₄₁-co-PtBMA₁₅₁ and oxidized copolymer P2 were consistent with suppressed lactonization. A single ν(CO) stretch was observed at 1715 cm⁻¹ (FIG. 6C) in both materials and was assigned to the tert-butyl ester. No γ-BL carbonyl stretch was observed at 1770 cm⁻¹. ¹H NMR spectra showed signatures of vinyl alcohol residues, including a methine resonance at δ 3.83 (CH—OH, FIG. 6D). Assignment of the δ 3.83 resonance to the PVA methine is supported by ¹³C DEPT NMR spectra and ¹H-¹³C HSQC spectroscopy (FIG. 17).

Methanolysis of Lactonized PVA-co-PMMA. Prior work on the acid-catalyzed methanolysis of γ-butyrolactone demonstrated that the equilibrium mixture favored the ring-opened form by approximately 3:1. Brown and Keblys, 1966. We therefore investigated whether the lactonized PVA-co-PMMA initially isolated after oxidation could be enriched in vinyl alcohol subunits. Alkaline methanolysis for 48 hours showed diminishment of the lactone FTIR resonance and preservation of the methyl ester resonance (P3, FIG. 7). A broad resonance at ca. 3350 cm⁻¹ consistent with the ν(OH) also intensified. The broad peak shifted to comparatively low frequency is consistent with a hydroxyl group engaged in extensive hydrogen-bonding, as seen in the homopolymer PVA. Krimm et al., 1956; Nagai et al., 1959. Based on these observations, the methanolysis product was assigned to a terpolymer of lactone, methyl ester, and vinyl alcohol units in an equilibrium distribution of the functional groups.

In summary, the presently disclosed subject matter demonstrates the utility of aromatic vinyl borane monomers for the preparation of copolymers inaccessible from traditional feedstocks. The free radical copolymerization of BN2VN with both MMA and tBMA is reported. Oxidation with Me₃NO.2H₂O in CPME yielded copolymers bearing both ester and lactone subunits arising from lactonization of the intermediate VA-MMA copolymer. Thermodynamic alcoholysis returned highly functionalized copolymers bearing vinyl alcohol, lactone, and ester side chains. The VA-MMA statistical copolymer cannot be prepared directly from vinyl acetate and MMA. In combination with Williams' work on mCPBA-mediated hydroboration-oxidation of polyesters, the present invention significantly expands the scope of functionally rich boron-functionalized polymers suitable for oxidative functionalization. Yi et al., 2019.

The functionally rich and polar polymers prepared herein are likely to have several potential applications. As both PMMA and PVA are biocompatible polymers, conjugates could be prepared by covalent attachment of a desired small molecule. The lactone substructures may impart unique mechanical properties to the polymers by reducing degrees of freedom along the backbone. Lactones have a rich history in polymer synthesis as monomers: O'Keefe et al., 2001, the presence of lactone functionality embedded along the polymer backbone may serve as sites for graft polymerization, Jenkins and Hudson, 2001, via ring-opening polymerization. Access to the novel structures described herein is made possible by an unconventional aromatic organoborane monomer. The incorporation of main group elements into polymeric materials is an active area of research yielding new insights relevant to optoelectronics, materials properties, and biology. Vidal and Jäkle, 2019; Jäkle, 2010; Messina et al., 2019; Marro et al., 2019; He and Baumgartner, 2013.

Accordingly, the presently disclosed subject matter provides a method for preparing a compound of formula (I) or formula (II);

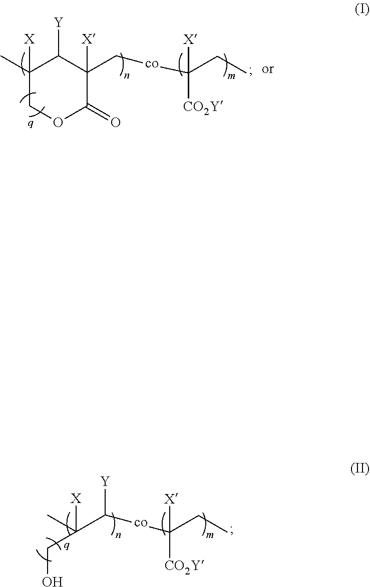

wherein:

each q is independently an integer selected from the group consisting of 0, 2, 3, 4, 5, 6, 7, and 8;

each n is independently an integer from 1 to 500;

each m is independently an integer from 1 to 1000;

X and X′ are each independently hydrogen or methyl;

Y is a hydrogen or an isobutyl group;

Y′ is selected from the group consisting of hydrogen, C₁-C₁₂ straightchain or branched alkyl, chloroalkyl, hydroxyalkyl, (dimethylamino)alkyl, (diethylamino)alkyl, cycloalkyl, phenyl, benzyl, and naphthyl; or a stereoisomer thereof;

the method comprising:

(a) contacting BN 2-vinylnaphthalene (BN2VN), or a derivative thereof, with methyl methacrylate (MMA), or a derivative thereof, in the presence of an initiator to form a first intermediate; and

(b) oxidizing the first intermediate to form a compound of formula (I) or formula (II).

In some embodiments, the BN 2-vinylnaphthalene (BN2VN), or a derivative thereof, has the following formula:

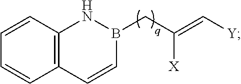

wherein:

X is a hydrogen or a methyl group;

Y is a hydrogen or an isobutyl group;

q is an integer selected from the group consisting of 0, 2, 3, 4, 5, 6, 7, and 8;
or a stereoisomer thereof.

In some embodiments, BN2VN or a derivative thereof is selected from the group consisting of

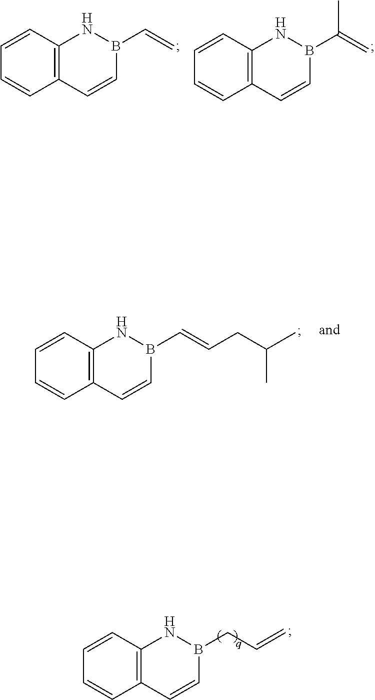

wherein q is an integer selected from the group consisting of 0, 2, 3, 4, 5, 6, 7, and 8 or a stereoisomer thereof.

In some embodiments, MMA or a derivative thereof has the following formula:

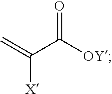

wherein:

X′ is a hydrogen or a methyl group;

Y′ is selected from the group consisting of hydrogen, C₁-C₁₂ straightchain or branched alkyl, chloroalkyl, hydroxyalkyl, (dimethylamino)alkyl, (diethylamino)alkyl, cycloalkyl, phenyl, benzyl, and naphthyl; or a stereoisomer thereof;

or a stereoisomer thereof.

In some embodiments, MMA or a derivative thereof is selected from the group consisting of:

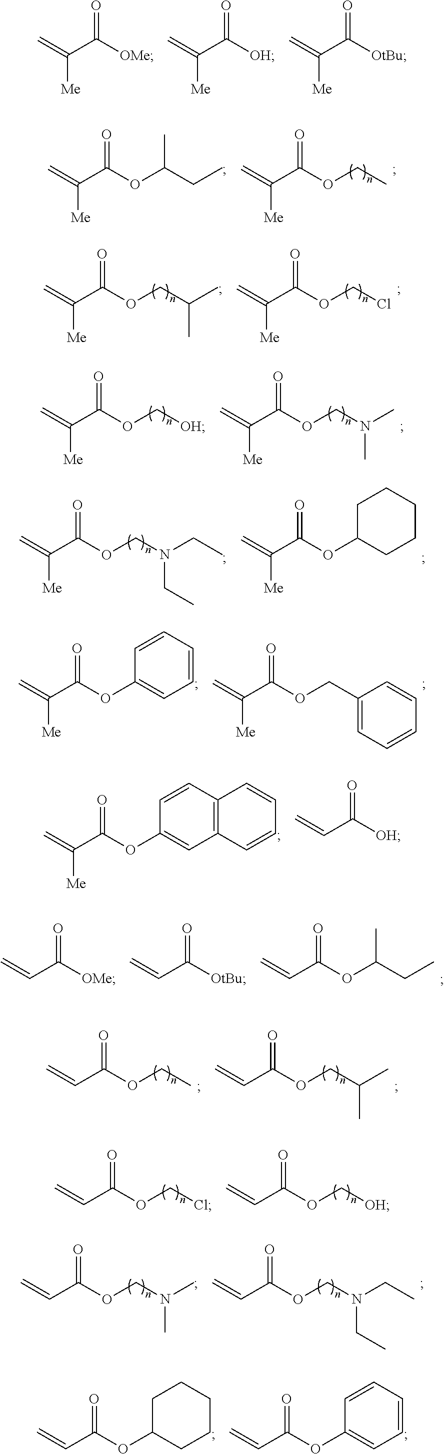

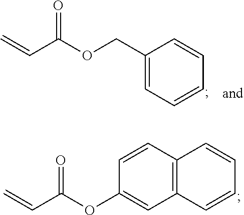

wherein n is an integer selected from the group consisting of 1, 2, 3, 4, 5, 6, 7, 8, 9, 10, 11, and 12, or a stereoisomer thereof.

In some embodiments, the method comprises contacting BN2VN with MMA or tert-butyl methacrylate (tBMA).

In some embodiments, the initiator comprises 2,2-azobis(2-methylpropionitrile) (AIBN).

In some embodiments, the first intermediate comprises:

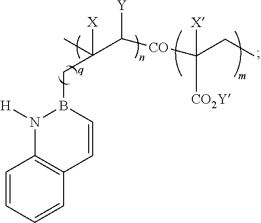

wherein:
q is an integer selected from the group consisting of 0, 2, 3, 4, 5, 6, 7, and 8;
n is an integer from 1 to 500;
m is an integer from 1 to 1000;
X and X′ are each independently hydrogen or methyl;
Y is a hydrogen or an isobutyl group;
Y′ is selected from the group consisting of hydrogen, C₁-C₁₂ straightchain or branched alkyl, chloroalkyl, hydroxyalkyl, (dimethylamino)alkyl, (diethylamino)alkyl, cycloalkyl, phenyl, benzyl, and naphthyl;
or a stereoisomer thereof.

In some embodiments, the first intermediate is:

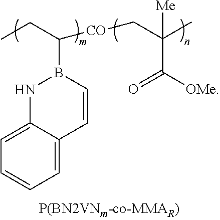

In some embodiments, the oxidizing step comprises contacting the first intermediate with Me₃NO.2H₂O and cyclopentyl methyl ether (CPME).

In some embodiments, the compound of formula (I) comprises:

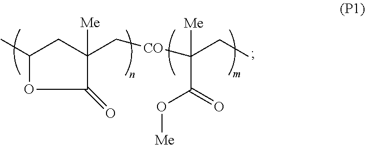

wherein n is an integer from 1 to 500 and m is an integer from 1 to 1000.

In some embodiments, the compound of formula (II) comprises:

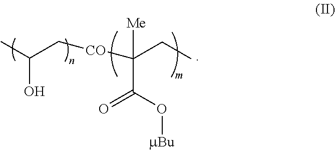

In some embodiments, the method further comprises contacting the compound of formula (I):

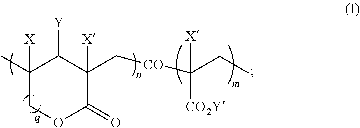

with a base to form a compound of formula (III):

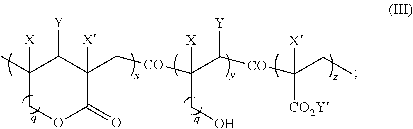

wherein:
q is an integer selected from the group consisting of 0, 2, 3, 4, 5, 6, 7, and 8;
x is an integer from 1 to 500;
y is an integer from 1 to 1000;
z is an integer from 1 to 1000;
X and X′ are each independently hydrogen or methyl;
Y is a hydrogen or an isobutyl group;
Y′ is selected from the group consisting of hydrogen, C₁-C₁₂ straightchain or branched alkyl, chloroalkyl, hydroxyalkyl, (dimethylamino)alkyl, (diethylamino)alkyl, cycloalkyl, phenyl, benzyl, and naphthyl; or a stereoisomer thereof.

In some embodiments, the base comprises NaOMe.

In some embodiments, the compound of formula (III) is:

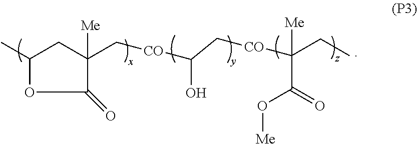

wherein x is an integer from 1 to 500, y is an integer from 1 to 1000 and z is an integer from 1 to 1000; or a stereoisomer thereof.

In some embodiments, the presently disclosed subject matter provides a compound of formula (III):

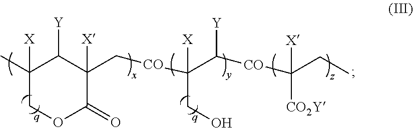

wherein:
q is an integer selected from the group consisting of 0, 2, 3, 4, 5, 6, 7, and 8;
x is an integer from 1 to 500;
y is an integer from 1 to 1000;
z is an integer from 1 to 1000;
X and X′ are each independently hydrogen or methyl;
Y is a hydrogen or an isobutyl group;
Y′ is selected from the group consisting of hydrogen, C₁-C₁₂ straightchain or branched alkyl, chloroalkyl, hydroxyalkyl, (dimethylamino)alkyl, (diethylamino)alkyl, cycloalkyl, phenyl, benzyl, and naphthyl; or a stereoisomer thereof.

In some embodiments, the compound of formula (III) is:

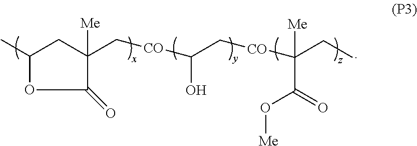

wherein x is an integer from 1 to 500, y is an integer from 1 to 1000 and z is an integer from 1 to 1000; or a stereoisomer thereof.

In some embodiments, the presently disclosed subject matter provides a compound of formula (I):

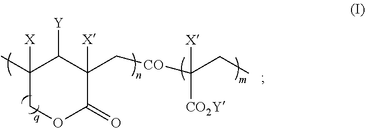

q is an integer selected from the group consisting of 0, 2, 3, 4, 5, 6, 7, and 8;

n is an integer from 1 to 500;

m is an integer from 1 to 1000;

X and X′ are each independently hydrogen or methyl;

Y is a hydrogen or an isobutyl group;

Y′ is selected from the group consisting of hydrogen, C₁-C₁₂ straightchain or branched alkyl, chloroalkyl, hydroxyalkyl, (dimethylamino)alkyl, (diethylamino)alkyl, cycloalkyl, phenyl, benzyl, and naphthyl; or a stereoisomer thereof.

In some embodiments, the presently disclosed subject matter provides a compound of formula (II):

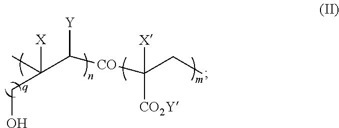

wherein:

q is an integer selected from the group consisting of 0, 2, 3, 4, 5, 6, 7, and 8;

n is an integer from 1 to 500;

m is an integer from 1 to 1000;

X and X′ are each independently hydrogen or methyl;

Y is a hydrogen or an isobutyl group;

Y′ is selected from the group consisting of hydrogen, C₁-C₁₂ straightchain or branched alkyl, chloroalkyl, hydroxyalkyl, (dimethylamino)alkyl, (diethylamino)alkyl, cycloalkyl, phenyl, benzyl, and naphthyl; or a stereoisomer thereof.

In some embodiments, the presently disclosed subject matter provides a compound of the formula:

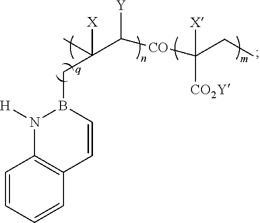

wherein:
q is an integer selected from the group consisting of 0, 2, 3, 4, 5, 6, 7, and 8;
n is an integer from 1 to 500;
m is an integer from 1 to 1000;
X and X′ are each independently hydrogen or methyl;
Y is a hydrogen or an isobutyl group;
Y′ is selected from the group consisting of hydrogen, C₁-C₁₂ straightchain or branched alkyl, chloroalkyl, hydroxyalkyl, (dimethylamino)alkyl, (diethylamino)alkyl, cycloalkyl, phenyl, benzyl, and naphthyl;
or a stereoisomer thereof.

The term “lactone” refers to cyclic esters, containing a 1-oxacycloalkane-2-one structure (—(C═O)—O—), or analogues having unsaturation or heteroatoms replacing one or more carbon atoms of the ring.

The term “lactonized poly(vinyl alcohol (PVA)-co-poly(methyl methacrylate)” refers to poly(vinyl alcohol (PVA)-co-poly(methyl methacrylate) comprising one or more lactone(s). The lactones may be the same lactone or different lactones.

The term hydrocarbon, as used herein, refers to any chemical group comprising hydrogen and carbon. The hydrocarbon may be substituted or unsubstituted. As would be known to one skilled in this art, all valencies must be satisfied in making any substitutions. The hydrocarbon may be unsaturated, saturated, branched, unbranched, cyclic, polycyclic, or heterocyclic. Illustrative hydrocarbons are further defined herein below and include, for example, methyl, ethyl, n-propyl, isopropyl, cyclopropyl, allyl, vinyl, n-butyl, tent-butyl, ethynyl, cyclohexyl, and the like.

The term “alkyl,” by itself or as part of another substituent, means, unless otherwise stated, a straight (i.e., unbranched) or branched chain, acyclic or cyclic hydrocarbon group, or combination thereof, which may be fully saturated, mono- or polyunsaturated and can include di- and multivalent groups, having the number of carbon atoms designated (i.e., C₁₋₁₀ means one to ten carbons, including 1, 2, 3, 4, 5, 6, 7, 8, 9, and 10 carbons). In particular embodiments, the term “alkyl” refers to C₁₋₂₀ inclusive, including 1, 2, 3, 4, 5, 6, 7, 8, 9, 10, 11, 12, 13, 14, 15, 16, 17, 18, 19, and 20 carbons, linear (i.e., “straight-chain”), branched, or cyclic, saturated or at least partially and in some cases fully unsaturated (i.e., alkenyl and alkynyl) hydrocarbon radicals derived from a hydrocarbon moiety containing between one and twenty carbon atoms by removal of a single hydrogen atom.

Representative saturated hydrocarbon groups include, but are not limited to, methyl, ethyl, n-propyl, isopropyl, n-butyl, isobutyl, sec-butyl, tent-butyl, n-pentyl, sec-pentyl, isopentyl, neopentyl, n-hexyl, sec-hexyl, n-heptyl, n-octyl, n-decyl, n-undecyl, dodecyl, cyclohexyl, (cyclohexyl)methyl, cyclopropylmethyl, and homologs and isomers thereof.

In particular embodiments, C₁-C₄ alkyl includes methyl, ethyl, n-propyl, isopropyl, n-butyl, isobutyl, sec-butyl, and tent-butyl.

“Branched” refers to an alkyl group in which a lower alkyl group, such as methyl, ethyl or propyl, is attached to a linear alkyl chain. “Lower alkyl” refers to an alkyl group having 1 to about 8 carbon atoms (i.e., a C₁₋₈ alkyl), e.g., 1, 2, 3, 4, 5, 6, 7, or 8 carbon atoms. “Higher alkyl” refers to an alkyl group having about 10 to about 20 carbon atoms, e.g., 10, 11, 12, 13, 14, 15, 16, 17, 18, 19, or 20 carbon atoms. In certain embodiments, “alkyl” refers, in particular, to C₁-C_{12,} including C₁, C₂, C₃, C₄, C₅, C₆, C₇, C₈, C₉, C₁₀, C₁₁, and C₁₂ straight-chain alkyls. In other embodiments, “alkyl” refers, in particular, to C₁-C₁₂, including C₁, C₂, C₃, C₄, C₅, C₆, C₇, C₈, C₉, C₁₀, C₁₁, and C₁₂ branched-chain alkyls.

Cycloalkyl” refer to a non-aromatic mono- or multicyclic ring system of about 3 to about 10 carbon atoms, e.g., 3, 4, 5, 6, 7, 8, 9, or 10 carbon atoms. The cycloalkyl group can be optionally partially unsaturated. The cycloalkyl group also can be optionally substituted with an alkyl group substituent as defined herein, oxo, and/or alkylene. There can be optionally inserted along the cyclic alkyl chain one or more oxygen, sulfur or substituted or unsubstituted nitrogen atoms, wherein the nitrogen substituent is hydrogen, unsubstituted alkyl, substituted alkyl, aryl, or substituted aryl, thus providing a heterocyclic group. Representative monocyclic cycloalkyl rings include cyclopentyl, cyclohexyl, and cycloheptyl. Multicyclic cycloalkyl rings include adamantyl, octahydronaphthyl, decalin, camphor, camphane, and noradamantyl, and fused ring systems, such as dihydro- and tetrahydronaphthalene, and the like.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments, ±100% in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

### EXAMPLES

The following Examples have been included to provide guidance to one of ordinary skill in the art for practicing representative embodiments of the presently disclosed subject matter. In light of the present disclosure and the general level of skill in the art, those of skill can appreciate that the following Examples are intended to be exemplary only and that numerous changes, modifications, and alterations can be employed without departing from the scope of the presently disclosed subject matter. The synthetic descriptions and specific examples that follow are only intended for the purposes of illustration, and are not to be construed as limiting in any manner to make compounds of the disclosure by other methods.

### Example 1

### Experimental Procedures

### 1.1 Instrumentation

¹H NMR, ¹³C {¹H} NMR, ¹¹B NMR and other 1D and 2D NMR experiments spectra were recorded on a Bruker UltraShield Avance III 400 MHz spectrometer and chemical shifts were reported in parts per million (ppm). Spectra were recorded in dichloromethane-d₂ with the residual solvent peak as the internal standard (¹H NMR: CH₂Cl₂, δ=5.32 ppm; ¹³C NMR: CH₂Cl₂, δ=53.84 ppm). Multiplicities are as indicated: s (singlet), d (doublet), t (triplet), q (quartet), p (pentet), m (multiplet), and br (broad). All polymer spectra were acquired using quartz NMR tubes from Wilmad. The UNIlab Plus Glove Box by MBRAUN was maintained under nitrogen atmosphere.

### 1.2 Gel Permeation Chromatography (GPC) Curves

Polymer molecular weights were measured by gel permeation chromatography (GPC) on a Tosoh Bioscience EcoSEC GPC workstation using butylated hydroxytoluene stabilized tetrahydrofuran (THF) as the eluent (0.35 mL min⁻¹, 40° C.) through TSKgel Super Multipore HZ-M guard column (4.6 mm ID×2.0 cm, 4 μm, Tosoh Bioscience) and a TSKgel Super Multipore HZ-M column (4.6 mm ID×15 cm, 4 μm, Tosoh Bioscience). Polystyrene standards (EasiVial PS-M, Agilent) were used to build a calibration curve. Processing was performed using EcoSEC Data Analysis software (Version 1.14, Tosoh Bioscience). Polymers were dissolved in THF (0.25 mg mL⁻¹), filtered (Millex-FG Syringe Filter Unit, 0.20 μm, PTFE, EMD Millipore), and injected using an auto-sampler (20 μL).

### 1.3 UV-Vis Spectroscopy

UV-Vis spectroscopy was performed on a Shimadzu UV-1800 UV-Vis spectrophotometer. The spectra were measured at room temperature in non-stabilized THF in a quartz cuvette (10 mm). All polymer solutions were made to the same concentration (0.0272 g L⁻¹) in non-stabilized THF and measured in a quartz cuvette (10 mm). 10 mL and 50 mL volumetric flasks were used for accurate volume measurement of solutions.

### 1.4 FTIR Spectroscopy

Fourier-transformed infrared (FTIR) spectroscopy was performed on a ThermoNicolet Nexus 670 FTIR spectrometer. Polymers were dissolved in dichloromethane (4 mg mL⁻¹), drop cast onto a polished KBr window (International Crystal Labs), and spectra were obtained at room temperature in transmission mode.

### 1.5 Differential Scanning Calorimetry (DSC) Curves

Differential scanning calorimetry (DSC) was carried out on a TA Instruments DSC Q20 V24.11 Build 124 and processing was performed using Universal V4.5A (TA Instruments). Polymer samples (1.0-3.0 mg) were sealed in hermetic aluminum pans, heated from 35 to 190° C. (10° C. min⁻¹), and cooled from 190 to 35° C., for two cycles under a purge gas of nitrogen (20 mL min⁻¹). Glass transition temperatures (T_{g}) were calculated from the second heating cycle and the midpoint of glass transition was reported as T_{g}. Elemental analysis (EA) was performed by Robertson Microlit Laboratories.

### 1.6 Chemicals

Unless otherwise specified, all chemicals were used as purchased without further purification. Solvents used for workups were reagent grade and used as received. Reaction solvents toluene (Fisher, certified ACS) was dried on a J. C. Meyer Solvent Dispensing System (SDS) using stainless steel columns packed with neutral alumina (except for toluene, which is dried with neutral alumina and Q5 reactant, a copper (II) oxide oxygen scavenger), following the manufacturer's recommendations for solvent preparation and dispensation. UV-Vis studies were performed in non-stabilized THF from EMD Millipore. GPC studies were performed in butylated hydroxytoluene stabilized THF from EMD Millipore.

BN 2-Vinylnaphthalene (BN2VN) was synthesized as previously described. van de Wouw et al., 2017; van de Wouw et al., 2018(a).

Methyl methacrylate (99%, contains ≤30 ppm MEHQ as inhibitor) and tert-butyl methacrylate (98%, contains 200 ppm MEHQ as inhibitor) were purchased from Sigma Aldrich and purified according to literature procedure. Armarego, 2003.

2,2′-Azobis(2-methylpropionitrile) (AIBN) (recrystallized, 99%), cyclopentyl methyl ether (CPME) (anhydrous, 99.9%), trimethylamine N-oxide dihydrate (98%), γ-Butyrolactone (≥99%), poly(acrylic acid) (average M_{w} 1800), dichloromethane, methanol, and Dowex® 50WX8 hydrogen form were purchased from Sigma Aldrich. Sodium methoxide (ACS reagent, 0.5M solution in methanol) was purchased from Fischer Scientific. Poly(tert-butyl methacrylate) (atactic, average Mₙ 24000) was purchased from Polymer Source. Dichloromethane-d₂ (D, 99.8%) was purchased from Cambridge Isotope Laboratories, Inc.

### Example 2

### Synthetic Procedures

### 2.1 BN2VN-MMA Free Radical Polymerization

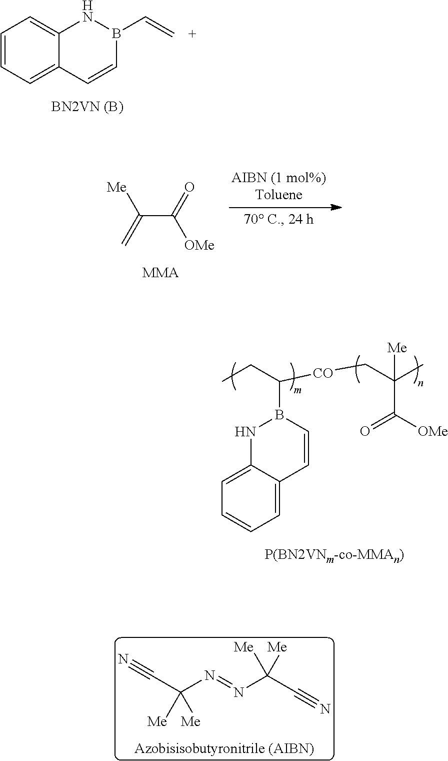

TABLE 5
Molecular weight properties of BN2VN-MMA copolymers.

| | Feed | Incorpora- | | | |
|---|---|---|---|---|---|
| | ratio | tion ratio | | | |
| | (B mol | (B mol | Yield | Mₙ^{[c]} | |
| Sample Name^{[a]} | %) | %)^{[b]} | (%) | (kDa) | M_{w}/Mₙ |
| PMMA | 0 | 0 | 89 | 34.1 | 1.92 |
| P(BN2VN₂₈-co- | 10.0 | 11.5 | 79 | 25.3 | 2.25 |
| MMA₂₁₀) | | | | | |
| P(BN2VN₃₀-co- | 20.0 | 18.0 | 75 | 18.5 | 2.46 |
| MMA₁₃₈) | | | | | |
| P(BN2VN₃₈-co- | 30.0 | 28.5 | 83 | 15.3 | 2.54 |
| MMA₉₄) | | | | | |
| P(BN2VN₄₀-co- | 40.0 | 42.7 | 80 | 11.6 | 2.53 |
| MMA₅₄) | | | | | |
| P(BN2VN₄₁-co- | 50.0 | 52.7 | 93 | 10.1 | 2.36 |
| MMA₃₇) | | | | | |
| PBN2VN | 100 | 100 | 37 | 5.48 | 1.51 |

ε320 = (28.1)χ − 0.244. EqS1
$mol {\%}_{BN2VN} = 100 \times ( \frac{χ}{155.01} ) / ( ( \frac{χ}{155.01} ) + ( \frac{1 - χ}{100.12} ) ) . EqS 2$
^{[a]}Samples named according to degree of polymerization of each monomer.
^{[b]}Determined from FIG. 10 and Eqs. S1-S2.
^{[c]}Determined by Gel Permeation Chromatography (GPC) relative to polystyrene standard.

### 2.1.1 General Procedure 1: Copolymer Synthesis

An oven-dried 15 mL heavy walled cylindrical pressure vessel equipped with a stir bar was brought into a nitrogen filled glove box and charged with the appropriate monomer(s) (10 mmol total) and AIBN (1 mol %, 0.1 mmol, 16.4 mg). The pressure vessel was sealed with a Teflon cap and brought out of the glove box, covered by aluminum foil, and heated (in a pre-heated oil bath) at 70° C. for 24 hours with vigorous stirring. Polymerization was cooled to room temperature and quenched by opening the reaction flask in air, dissolving in dichloromethane (2×5 mL), and immediately pipetting the solution into a beaker of methanol (200 mL). Over the course of 20 minutes the polymer precipitated from solution and was isolated by filtering off the methanol solution through a Celite-padded fritted funnel. Collected polymer was washed with additional methanol (2×50 mL), then eluted with dichloromethane (40 mL) into an empty round bottom flask. The precipitation-filtration process was repeated for twice and the final precipitation yielded a powdery precipitate. The precipitate was transferred to a tared scintillation vial for storage, dried on the Schenk line for about 30 min, and then finally dried in a vacuum oven for 36 hours at 85° C.

### P(BN2VN₂₈-co-MMA₂₁₀)

Synthesized according to General Procedure 1: BN2VN (1 mmol, 155.0 mg) and MMA (9 mmol, 898.2 mg) to yield a light-yellow powder (842.6 mg, 80%).

¹H NMR δ H (400 MHz, CD₂Cl₂): 8.22-6.17 (m, 7H), 3.98-2.73 (m, 28H), 2.30-0.25 (m, 51H).

¹³C {¹H} NMR δ C (101 MHz, CD₂Cl₂): 178.5, 144.7, 140.2, 129.5, 128.5, 125.6, 121.1, 118.2, 54.81, 44.8, 21.3, 19.0, 16.8.

¹¹B NMR δ B (128 MHz, CD₂Cl₂): 34.84 (br).

FTIR (KBr, thin film) 3354, 2949, 1729, 1615, 1564, 1479, 1447, 1271, 1241, 1192, 1149, 763 cm⁻¹.

Anal. Found: C, 62.39; H, 8.06; N, 1.45. Calc. C, 63.16; H, 7.75; N, 1.66. P(BN2VN₃₀-co-MMA₁₃₈)

Synthesized according to General Procedure 1: BN2VN (2 mmol, 313.1 mg) and MMA (8 mmol, 803.4 mg) to yield a light-yellow powder (841.8 mg, 75%).

¹H NMR δ H (400 MHz, CD₂Cl₂): 8.29-6.25 (m, 7H), 4.03-2.53 (m, 14H), 2.41-0.26 (m, 26H).

¹³C {¹H} NMR δ C (101 MHz, CD₂Cl₂): 178.2, 144.6, 140.2, 129.5, 128.5, 125.4, 121.1, 118.2, 54.7, 52.0, 44.8, 40.4, 29.7, 25.6, 21.3, 19.0, 16.8.

¹¹B NMR δ B (128 MHz, CD₂Cl₂): 34.64 (br).

FTIR (KBr, thin film) 3357, 2949, 1730, 1615, 1564, 1444, 1271, 1241, 1193, 1149, 763 cm⁻¹.

Anal. Found: C, 64.07; H, 7.33; N, 2.28. Calc. C, 64.53; H, 7.63; N, 2.42. P(BN2VN₃₈-co-MMA₉₄)

Synthesized according to General Procedure 1: BN2VN (3 mmol, 465.0 mg) and MMA (7 mmol, 697.0 mg) to yield a light-yellow powder (964.5 mg, 83%).

¹H NMR δ H (400 MHz, CD₂Cl₂): 8.16-6.16 (m, 7H), 4.03-2.52 (m, 8H), 2.32-0.18 (m, 17H).

¹³C {¹H} NMR δ C (101 MHz, CD₂Cl₂): 177.9, 144.6, 140.3, 129.5, 128.5, 125.5, 121.1, 118.2, 54.7, 51.9, 44.9, 40.4, 30.1, 24.8, 21.3, 16.6.

¹¹B NMR δ B (128 MHz, CD₂Cl₂): 34.69 (br).

FTIR (KBr, thin film) 3357, 2948, 1728, 1615, 1563, 1476, 1440, 1240, 1192, 1148, 808, 762 cm⁻¹.

Anal. Found: C, 63.66; H, 7.61; N, 2.32. Calc. C, 67.19; H, 7.46; N, 3.67.

### P(BN2VN₄₀-co-MMA₅₄)

Synthesized according to General Procedure 1: BN2VN (4 mmol, 619.4 mg) and MMA (6 mmol, 601.3 mg) to yield a yellow powder (979.0 mg, 80%).

¹H NMR δ H (400 MHz, CD₂Cl₂): 7.34 (m, 7H), 4.06-2.50 (m, 6H), 2.45-0.23 (m, 13H).

¹³C {¹H} NMR δ C (101 MHz, CD₂Cl₂): 177.6, 144.6, 140.3, 129.5, 128.4, 125.5, 121.0, 118.2, 54.7, 51.9, 45.3, 40.1, 29.9, 26.0, 21.3, 19.3, 16.8.

¹¹B NMR δ B (128 MHz, CD₂Cl₂): 34.15 (br).

FTIR (KBr, thin film) 3358, 2947, 1728, 1615, 1563, 1476, 1440, 1239, 1193, 1138, 762 cm⁻¹.

Anal. Found: C, 67.75; H, 7.33; N, 4.23. Calc. C, 69.74; H, 7.23; N, 5.07.

### P(BN2VN₄₁-co-MMA₃₇)

Synthesized according to General Procedure 1: BN2VN (5 mmol, 755.1 mg) and MMA (5 mmol, 497.8 mg) to yield a yellow powder (1165.2 mg, 93%).

¹H NMR δ H (400 MHz, CD₂Cl₂): 8.29-6.01 (m, 7H), 3.98-2.51 (m, 4H), 2.44-0.23 (m, 10H).

¹³C {¹H} NMR δ C (101 MHz, CD₂Cl₂): 178.2, 144.5, 140.3, 129.5, 128.4, 125.5, 121.0, 118.2, 54.6, 51.8, 45.1, 40.0, 29.9, 26.6, 21.8, 19.5, 17.2.

¹¹B NMR δ B (128 MHz, CD₂Cl₂): 34.26 (br).

FTIR (KBr, thin film) 3359, 2947, 1727, 1615, 1597, 1562, 1475, 1439, 1386, 1344, 1279, 1238, 1193, 1136, 807, 762 cm⁻¹.

Anal. Found: C, 67.64; H, 7.29; N, 4.22. Calc. C, 70.07; H, 6.95; N, 5.87.

### 2.1.2 General Procedure 2: Homopolymer Synthesis

An oven-dried 2-5 mL microwave reaction vial equipped with a stir bar was brought into a nitrogen filled glove box and charged with the appropriate monomer (5 mmol total) and AIBN (1 mol %, 0.05 mmol, 8.2 mg). The microwave vial was tightly sealed with an aluminum and Teflon cap and brought out of the glove box, wrapped in aluminum foil, and heated (in a preheated pie-plate) at 70° C. for 24 hours with vigorous stirring. Polymerization was cooled to room temperature and quenched by opening the reaction flask in air, dissolving in dichloromethane (2×2.5 mL), and immediately pipetting the solution into a beaker of methanol (100 mL). Over the course of 20 minutes the polymer precipitated from solution and was isolated by filtering off the methanol solution through a Celite-padded fritted funnel. Collected polymer was washed with additional methanol (2×25 mL), then eluted with dichloromethane (20 mL) into an empty round bottom flask. The precipitation-filtration process was repeated twice and the final precipitation yielded a powdery precipitate. The precipitate was transferred to a tared scintillation vial for storage, dried on the Schenk line for about 30 min, and then finally dried in a vacuum oven for about 36 hours at 85° C.

### PMMA₃₄₀

Synthesized according to General Procedure 2: MMA (5 mmol, 500.1 mg) to yield a white powder (422.7 mg, 89%).

NMR δ H (400 MHz, CD₂Cl₂): 3.55 (s, 3H), 2.23-1.28 (m, 2H), 1.25-0.43 (m, 3H).

¹³C {¹H} NMR δ C (101 MHz, CD₂Cl₂): 178.1, 54.7, 51.9, 44.9, 21.3, 18.9, 16.8.

FTIR (KBr, thin film) 2950, 1729, 1448, 1270, 1242, 1192, 1149 cm⁻¹.

Anal. Found: C, 59.65; H, 7.98; N, 0.24. Calc. C, 59.99; H, 7.99; N, 0.32.

### PBN2VN₃₅

Synthesized according to General Procedure 2: BN2VN (5 mmol, 775.1 mg) to yield a yellow powder (278.2 mg, 36%).

¹H NMR δ H (400 MHz, CD₂Cl₂): 8.41-5.84 (m, 7H), 2.43-0.12 (m, 4H).

¹³C {¹H} NMR δ C (101 MHz, CD₂Cl₂): 144.1, 140.3, 129.4, 128.1, 125.5, 120.7, 118.0, 38.7, 29.9.

¹¹B NMR δ B (128 MHz, CD₂Cl₂): 33.05 (br).

FTIR (KBr, thin film) 3373, 2885, 1614, 1595, 1560, 1474, 1436, 1385, 1343, 1279, 1208, 1154, 1135, 806, 760, 709, 593 cm⁻¹.

Anal. Found: C, 76.09; H, 6.17; N, 8.64. Calc 80.45; H, 6.74; N, 9.81.

### 2.1.3 BN2VN-MMA Copolymer Oxidation

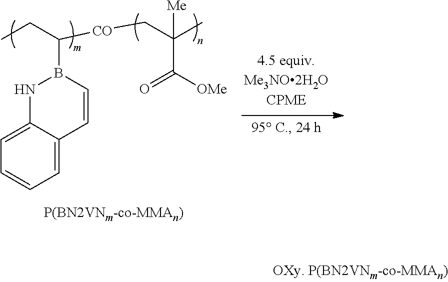

TABLE 6
Average molar mass and molar mass distribution of
Oxy. P(BN2VN-co-MMA) before and after oxidations.

| | Before Me₃NO | | | After Me₃NO | | | BN |
|---|---|---|---|---|---|---|---|
| | Mₙ^{[a]} | | | Mₙ^{[a]} | | | Removal |
| Sample Name | (kDa) | M_{w}/Mₙ | ∈320 | (kDa) | M_{w}/Mₙ | ∈320 | (%)^{[b]} |
| Oxy. P(BN2VN₂₈-coMMA₂₁₀) | 25.3 | 2.25 | 4.45 | 23.0 | 2.45 | 0.16 | 85.2 |
| Oxy. P(BN2VN₃₀-coMMA₁₃₈) | 18.5 | 2.46 | 6.89 | 14.4 | 2.70 | 0.25 | 87.0 |
| Oxy. P(BN2VN₃₈-co-MMA₉₄) | 15.3 | 2.54 | 10.5 | 13.2 | 3.08 | 0.38 | 91.8 |
| Oxy. P(BN2VN₄₀-co-MMA₅₄) | 11.6 | 2.53 | 14.8 | 9.89 | 2.73 | 0.53 | 91.8 |
| Oxy. P(BN2VN₄₁-co-MMA₃₇) | 10.1 | 2.36 | 17.5 | 8.45 | 2.40 | 0.63 | 92.2 |

^{[a]}Determined by Gel Permeation Chromatography (GPC).
^{[b]}Determined from FIG. 10 and Eqs. S1-S2.

### 2.1.4 General Procedure 3

An oven-dried Schlenk flask (100 mL or 250 mL depends on solvent volumes) equipped with a stir bar and a rubber septum sealed reflux condenser was charged with copolymer (300 mg total) and Me₃NO.2H₂O (4.5 equiv., 0.01 M). The flask was purged and backfilled with argon for 3 cycles. Sure-sealed CPME (33 mL-122 mL) was added by syringe transfer. The reaction mixture was heated in an oil bath to 95° C. for 24 hours with vigorous stirring under argon. An oil bubbler was connected to the condenser through the rubber septum to release trimethylamine. The oxidation was cooled to room temperature and quenched by opening the reaction flask in air and diluted in dichloromethane (20 mL). Methanol was added and solvent removed under reduced pressure by rotary evaporation. This step converts boric acid to trimethyl borate, which is volatile. Methanol addition and rotary evaporation was repeated five more times. The solid product was dissolved in dichloromethane (30 mL) and transferred to a separatory funnel. The organic layer was washed with water (60 mL) to remove remaining Me₃NO.2H₂O. The dichloromethane layer was concentrated to appx. 7 mL by rotary evaporation and pipetted into a beaker containing a methanol/H₂O (100 mL:50 mL) solution to remove indole. Over the course of 20 minutes the polymer precipitated from the solution and was isolated by vacuum filtration. The collected polymer was washed with additional 2:1 v/v methanol/H₂O solution (2×40 mL) and eluted with dichloromethane (20 mL) into a round bottom flask, which yielded a powdery precipitate after solvent removal by rotary evaporation. The precipitate was transferred to a tared scintillation vial for storage, dried on the Schenk line for about 30 min, and finally dried in a vacuum oven for about 36 hours at 85° C.

### Oxy. P(BN2VN₂₈-co-MMA₂₁₀)

Synthesized according to General Procedure 3: P(BN2VN₂₈-co-MMA₂₁₀) (300.3 mg), Me₃NO.2H₂O (170.5 mg), and CPME (33 mL) to yield a white powder (228.3 mg, 80%).

¹H NMR δ H (400 MHz, CD₂Cl₂): 8.02-6.43 (m, 1H), 4.29 (d, J=78.1 Hz, 1H), 3.52 (d, J=38.9 Hz, 4H), 2.45-0.45 (m, 8H).

¹³C {¹H} NMR δ C (101 MHz, CD₂Cl₂): 180.3, 177.7, 129.1, 128.1, 125.1, 120.7, 117.8, 73.7, 72.2, 54.4, 51.5, 44.4, 20.9, 18.5, 16.3.

FTIR (KBr, thin film) 2952, 2845, 1771, 1732, 1615, 1565, 1435, 1386, 1260, 1094, 1021, 992, 913, 842, 800, 751 cm⁻¹.

### Oxy. P(BN2VN₃₀-co-MMA₁₃₈) (P1)

Synthesized according to General Procedure 3: P(BN2VN₃₀-co-MMA₁₃₈) (2 mmol, 298.3 mg) Me₃NO.2H₂O (250.5 mg), and CPME (48 mL) to yield a light-yellow powder (207.3 mg, 88%).

¹H NMR δ H (400 MHz, CD₂Cl₂): 8.08-6.47 (m, 1H), 4.29 (d, J=76.2 Hz, 1H), 3.97-2.81 (m, 4H), 2.51-0.46 (m, 9H).

¹³C {¹H} NMR δ C (101 MHz, CD₂Cl₂): 80.2, 177.7, 139.6, 129.1, 128.1, 125.1, 120.7, 117.8, 73.7, 72.5, 51.5, 44.4, 29.6, 20.9, 18.6, 16.2.

FTIR (KBr, thin film) 2992, 2950, 1771, 1731, 1615, 1448, 1386, 1241, 1192, 1149, 1024, 989, 842, 809, 752 cm⁻¹.

### Oxy. P(BN2VN₃₈-co-MMA₉₄)

Synthesized according to General Procedure 3: P(BN2VN₃₈-co-MMA₉₄) (302.5 mg), Me₃NO.2H₂O (385.7 mg), and CPME (75 mL) to yield a light-yellow powder (132.6 mg, 51%).

¹H NMR δ H (400 MHz, CD₂Cl₂): 7.72-6.24 (m, 1H), 4.31 (d, J=74.8 Hz, 1H), 3.89-2.70 (m, 4H), 2.66-0.40 (m, 10H).

¹³C {¹H} NMR δ C (101 MHz, CD₂Cl₂): 180.2, 177.7, 73.7, 72.6, 54.3, 51.6, 44.4, 41.4, 29.6, 22.7, 18.6, 16.2.

FTIR (KBr, thin film) 2950, 1770, 1728, 1450, 1385, 1356, 1240, 1192, 1150, 1025, 989, 753 cm⁻¹.

### Oxy. P(BN2VN₄₀-co-MMA₅₄)

Synthesized according to General Procedure 3: P(BN2VN₄₀-co-MMA₅₄) (298.4 mg), Me₃NO.2H₂O (530.5 mg), and CPME (103 mL) to yield a yellow powder (90.0 mg, 36%).

¹H NMR δ H (400 MHz, CD₂Cl₂): 8.14-6.42 (m, 1H), 4.57 (s, 1H), 3.40 (t, J=128.3 Hz, 4H), 2.59-0.44 (m, 12H).

¹³C NMR δ C (101 MHz, CD₂Cl₂): 180.1, 177.7, 73.7, 54.2, 51.6, 44.4, 41.0, 29.6, 22.7, 18.6, 16.3.

FTIR (KBr, thin film) 2950, 1770, 1729, 1450, 1385, 1355, 1239, 1193, 1150, 1026, 989, 754 cm⁻¹.

### Oxy. P(BN2VN₄₁-co-MMA₃₇)

Synthesized according to General Procedure 3: P(BN2VN₄₁-co-MMA₃₇) (297.5 mg), Me₃NO.2H₂O (627 mg), and CPME (122 mL) to yield a brown powder (48 mg, 20%).

¹H NMR δ H (400 MHz, CD₂Cl₂): 8.12-6.31 (m, 1H), 4.59 (s, 1H), 2.91-2.67 (m, 4H), 2.60-0.48 (m, 14H).

¹³C NMR δ C (101 MHz, CD₂Cl₂): 180.4, 178.0, 73.8, 51.6, 44.4, 40.7, 29.6, 22.8, 18.6, 16.3.

FTIR (KBr, thin film) 2950, 1770, 1731, 1453, 1384, 1355, 1193, 1150, 1027, 990, 756 cm⁻¹.

### 2.2 BN2VN-tBMA Copolymer Synthesis and Oxidation

### P(BN2VN₄₁-co-tBMA₁₅₁)

Synthesized according to General Procedure 1: BN2VN (2 mmol, 755.1 mg) and tBMA (8 mmol, 1137.1 mg) to yield a yellow powder (759.4 mg, 52%). ε320:5.00 Mₙ (kDa):28.4 M_{w}/Mₙ:2.09.

¹H NMR δ H (400 MHz, CD₂Cl₂): 8.08-6.50 (m, 1 H), 2.22-0.32 (m, 17 H).

¹³C NMR δ C (101 MHz, CD₂Cl₂): 177.24, 143.98, 139.89, 129.07, 127.91, 125.24, 120.53, 117.93, 80.08, 46.18, 27.55, 20.13, 17.77.

FTIR (KBr, thin film) 3392, 2977, 2933, 1720, 1615, 1563, 1476, 1457, 1392, 1367, 1250, 1140, 918, 848, 762, 734 cm⁻¹.

### Oxy. P(BN2VN₄₁-co-tBMA₁₅₁) (P2)

Synthesized according to General Procedure 3: P(BN2VN₄₁-co-tBMA151) (300.3 mg), Me₃NO.2H₂O (211.7 mg), and CPME (42 mL) to yield a light-yellow powder (155.5mg, 56%). ε320:1.98 Mₙ (kDa):26.9 BN Removal ratio:60.5%.

¹H NMR δ H (400 MHz, CD₂Cl₂): 8.06-6.30 (m, 7 H), 4.18-3.35 (m, 1 H), 2.44-0.18 (m, 658 H).

¹³C {¹H} NMR δ C (101 MHz, CD₂Cl₂): 177.08, 176.56, 80.63, 64.92, 46.18, 27.55, 18.58, 17.83.

FTIR (KBr, thin film) 2977, 2934, 1721, 1615, 1566, 1477, 1457, 1393, 1367, 1250, 1140, 919, 848, 755, 734 cm⁻¹.

### 8.4 BN2VN-MMA Copolymer Methanolysis

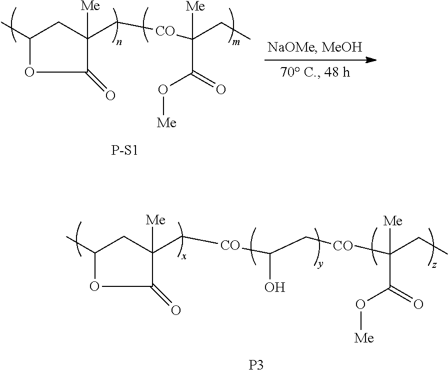

P-S1 was synthesized from MMA and BN2VN according to General Procedure 1 (yielding PBN2VN₃₇-co-PMMA₈₈) followed by General Procedure 3. An oven-dried 2-5 mL microwave reaction vial equipped with a stir bar were brought into a nitrogen filled glove box and charged with P-S1 (20 mg) and NaOMe solution (0.5M, 2 mL). The microwave vial was tightly sealed with a Teflon cap and brought out of the glove box, wrapped in aluminum foil, and heated at 70° C. in a pie plate for 48 hours with vigorous stirring. The reaction was cooled to room temperature and quenched by opening the microwave reaction vial in air and quickly adding and shaking with Dowex 50WX8 hydrogen form. The pH of the solution was adjusted to 7. The polymer was collected by filtering off the Dowex 50WX8 hydrogen form through a celite-padded fritted funnel and rinsed with methanol (30 mL). The solvent was then removed under reduced pressure by rotary evaporation. The dry polymer was transferred into a to a tared scintillation vial for storage, dried on the Schenk line for about 30 min, and finally dried in a vacuum oven for about 36 hours at 85° C.

### P(BN2VN₃₇-co-MMA₈₈)

Synthesized according to General Procedure 1: Toluene (0.5 mL), AIBN (8.2 mg), BN2VN (1.5 mmol, 232.4 mg), and MMA (3.5 mmol, 349.1 mg) to yield a yellow powder (484.3 mg, 83%).

FTIR (KBr, thin film) 3358, 2948, 1729, 1615, 1564, 1441, 1239, 1192, 1148, 762 cm⁻¹.

### Oxy. P(BN2VN₃₇-co-MMA₈₈) (P-S1)

Synthesized according to Copolymer Oxidation using P(BN2VN₄₁-co-tBMA₁₅₁) (150.3 mg), Me₃NO.2H₂O (195.1 mg), and CPME (37 mL) to yield a light-yellow powder (68.9 mg, 54%). FTIR (KBr, thin film) 2977, 2934, 1721, 1615, 1566, 1477, 1457, 1393, 1367, 1250, 1140, 919, 848, 755, 734 cm⁻¹.

### Oxy. P(BN2VN₃₇-co-MMA₈₈) After Methanolysis for 48 h (P3)

Synthesized according to Methanolysis of Lactonized Polymer using Oxy. P(BN2VN₄₁-co-tBMA₁₅₁) (20 mg) and NaOMe (2 mL) to yield a light-yellow powder. FTIR (KBr, thin film) 2950, 1771, 1728, 1449, 1240, 1192, 1149, 754 cm⁻¹.

### REFERENCES

All publications, patent applications, patents, and other references mentioned in the specification are indicative of the level of those skilled in the art to which the presently disclosed subject matter pertains. All publications, patent applications, patents, and other references are herein incorporated by reference to the same extent as if each individual publication, patent application, patent, and other reference was specifically and individually indicated to be incorporated by reference. It will be understood that, although a number of patent applications, patents, and other references are referred to herein, such reference does not constitute an admission that any of these documents forms part of the common general knowledge in the art.

Franssen, N. M. G.; Reek, J. N. H.; de Bruin, B. Synthesis of Functional ‘Polyolefins’: State of the Art and Remaining Challenges. Chem. Soc. Rev. 2013, 42 (13), 5809-5832. https://doi.org/10.1039/c3cs60032g.

Nakamura, A.; Ito, S.; Nozaki, K. Coordination-Insertion Copolymerization of Fundamental Polar Monomers. Chem. Rev. 2009, 109 (11), 5215-5244. https://doi.org/10.1021/cr900079r.

Mokwena, K. K.; Tang, J. Ethylene Vinyl Alcohol: A Review of Barrier Properties for Packaging Shelf Stable Foods. Crit. Rev. Food Sci. Nutr. 2012, 52 (7), 640-650. https://doi.org/10.1080/10408398.2010.504903.

Nagara, Y.; Nakano, T.; Okamoto, Y.; Gotoh, Y.; Nagura, M. Properties of Highly Syndiotactic Poly(Vinyl Alcohol). Polymer (Guildf). 2001, 42 (24), 9679-9686. https://doi.org/10.1016/S0032-3861(01)00493-1.

Hallensleben, M. L.; Fuss, R.; Mummy, F. Polyvinyl Compounds, Others. In Ullmann's Encyclopedia of Industrial Chemistry; Wiley-VCH Verlag GmbH & Co. KGaA: Weinheim, Germany, 2015; pp 1-23. https://doi.org/10.1002/14356007.a21_743.pub2.

Ito, S.; Munakata, K.; Nakamura, A.; Nozaki, K. Copolymerization of Vinyl Acetate with Ethylene by Palladium/Alkylphosphine-Sulfonate Catalysts. J. Am. Chem. Soc. 2009, 131 (41), 14606-14607. https://doi.org/10.1021/ja9050839.

Wakioka, M.; Baek, K. Y.; Ando, T.; Kamigaito, M.; Sawamoto, M. Possibility of Living Radical Polymerization of Vinyl Acetate Catalyzed by Iron(i) Complex [4]. Macromolecules 2002, 35 (2), 330-333. https://doi.org/10.1021/ma0115444.

Liao, C.-M.; Hsu, C.-C.; Wang, F.-S.; Wayland, B. B.; Peng, C.-H. Living Radical Polymerization of Vinyl Acetate and Methyl Acrylate Mediated by Co(Salen*) Complexes. Polym. Chem. 2013, 4 (10), 3098. https://doi.org/10.1039/c3py00282a.

Mayo, F. R.; Lewis, F. M.; Walling, C. Copolymerization. VIII. The Relation Between Structure and Reactivity of Monomers in Copolymerization. J. Am. Chem. Soc. 1948(a), 70 (4), 1529-1533. https://doi.org/10.1021/ja01184a070.

Mayo, F. R.; Walling, C.; Lewis, F. M.; Hulse, W. F. Copolymerization. V. Some Copolymerizations of Vinyl Acetate. J. Am. Chem. Soc. 1948(b), 70 (4), 1523-1525. https://doi.org/10.1021/ja01184a067.

van de Wouw, H. L.; Lee, J. Y.; Klausen, R. S. Gram-Scale Free Radical Polymerization of an Azaborine Vinyl Monomer. Chem. Commun. 2017, 53, 7262-7265. https://doi.org/10.1039/C7CCO2300F.

van de Wouw, H. L.; Lee, J. Y.; Awuyah, E. C.; Klausen, R. S. A BN Aromatic Ring Strategy for Tunable Hydroxy Content in Polystyrene. Angew. Chemie Int. Ed. 2018(a), 57 (6), 1673-1677. https://doi.org/10.1002/anie.201711650.

van de Wouw, H. L.; Awuyah, E. C.; Bans, J. I.; Klausen, R. S. An Organoborane Vinyl Monomer with Styrene-like Radical Reactivity: Reactivity Ratios and Role of Aromaticity. Macromolecules 2018(b), 51 (16), 6359-6368. https://doi.org/10.1021/acs.macromol.8b01368.

Mendis, S. N.; Zhou, T.; Klausen, R. S. Syndioselective Polymerization of a BN Aromatic Vinyl Monomer. Macromolecules 2018, 51 (17), 6859-6864. https://doi.org/10.1021/acs.macromol.8b01707.

van de Wouw, H. L.; Klausen, R. S. BN Polystyrenes: Emerging Optical Materials and Versatile Intermediates. J. Org. Chem. 2019, 84 (3), 1117-1125. https://doi.org/10.1021/acs.joc.8b02921.

Bosdet, M. J. D.; Piers, W. E. B—N as a C—C Substitute in Aromatic Systems. Can. J. Chem. 2009, 87 (1), 8-29. https://doi.org/10.1139/v08-110.

Campbell, P. G.; Marwitz, A. J. V.; Liu, S.-Y. Recent Advances in Azaborine Chemistry. Angew. Chemie Int. Ed. 2012, 51 (25), 6074-6092. https://doi.org/10.1002/anie.201200063.

Giustra, Z. X.; Liu, S. Y. The State of the Art in Azaborine Chemistry: New Synthetic Methods and Applications. J. Am. Chem. Soc. 2018, 140 (4), 1184-1194. https://doi.org/10.1021/jacs.7b09446.

Ouchi, M.; Nishikawa, T. An Alkenyl Boronate as a Monomer for Radical Polymerizations: Boron as a Guide for Chain Growth and as a Replaceable Side Chain for Post-Polymerization Transformation. Angew. Chemie Int. Ed. 2019. https://doi.org/10.1002/anie.201905135.

Chung, T. C.; Raate, M.; Berluche, E.; Schulz, D. N. Synthesis of Functional Hydrocarbon Polymers with Well-Defined Molecular Structures. Macromolecules 1988, 21 (7), 1903-1907. https://doi.org/10.1021/ma00185a003.

Chung, T. C.; Rhubright, D. Functionalization of Polypropylene by Hydroboration. J. Polym. Sci. Part A Polym. Chem. 1993, 31 (11), 2759-2763. https://doi.org/10.1002/pola.1993.080311112.

Herz, K.; Imbrich, D. A.; Unold, J.; Xu, G.; Speiser, M.; Buchmeiser, M. R. Functional ROMP-Derived Poly(Cyclopentene)S. Macromol. Chem. Phys. 2013, 214 (13), 1522-1527. https://doi.org/10.1002/macp.201300264.

Tanaka, R.; Kasai, Y.; Shinzawa, M.; Cai, Z.; Nakayama, Y.; Shiono, T. Synthesis of a Multiblock Copolymer of Cis-1,4-Polybutadiene and Poly(3-Buten-1-01). Macromol. Chem. Phys. 2014, 215 (9), 888-892. https://doi.org/10.1002/macp.201400016.

Kondo, Y.; Garcia-Cuadrado, D.; Hartwig, J. F.; Boaen, N. K.; Wagner, N. L.; Hillmyer, M. A. Rhodium-Catalyzed, Regiospecific Functionalization of Polyolefins in the Melt. J. Am. Chem. Soc. 2002, 124 (7), 1164-1165. https://doi.org/10.1021/ja016763j.

Bae, C.; Hartwig, J. F.; Boaen Harris, N. K.; Long, R. 0.; Anderson, K. S.; Hillmyer, M. A. Catalytic Hydroxylation of Polypropylenes. J. Am. Chem. Soc. 2005(a), 127 (2), 767-776. https://doi.org/10.1021/ja044440s.

Bae, C.; Hartwig, J. F.; Chung, H.; Harris, N. K.; Switek, K. A.; Hillmyer, M. A. Regiospecific Side-Chain Functionalization of Linear Low-Density Polyethylene with Polar Groups. Angew. Chemie Int. Ed. 2005(b), 44 (39), 6410-6413. https://doi.org/10.1002/anie.200501837.

Wang, H.; Kolodka, E.; Tande, B. M. Thermomechanical and Rheological Studies of Copolymers of Methyl Methacrylate with a Series of Linear Vinyl Esters. Ind. Eng. Chem. Res. 2013, 52 (14), 5111-5119. https://doi.org/10.1021/ie400090t.

Peixoto, L. S.; Cordeiro, F. B.; Melo, P. A.; Nele, M.; Pinto, J. C. Synthesis of Spherical Core-Shell PVAc-Co-PMMA/PVA Particles for Use in Vascular Embolization. Macromol. Symp. 2011, 299-300 (1), 132-138. https://doi.org/10.1002/masy.200900152.

Kabalka, G. W.; Hedgecock, H. C. Mild and Convenient Oxidation Procedure for the Conversion of Organoboranes to the Corresponding Alcohols. J. Org. Chem. 1975, 40 (12), 1776-1779. https://doi.org/10.1021/jo00900a022.

Kabalka, G. W. Oxidation of Organoboranes with Trimethylamine N-Oxide Dihydrate. J. Organomet. Chem. 1977, 125 (2), 273-280. https://doi.org/10.1016/S0022-328X(00)89445-0.

Wrackmeyer, B. Carbon-13 NMR Spectroscopy of Boron Compounds. Prog. Nucl. Magn. Reson. Spectrosc. 1979, 12 (4), 227-259. https://doi.org/10.1016/0079-6565(79)80003-5.

Lin, H.; McConnell, C. R.; Jilus, B.; Liu, S.-Y.; Jäkle, F. Changing up BN-Polystyrene: Effect of Substitution Pattern on the Free-Radical Polymerization and Polymer Properties. Macromolecules 2019, acs.macromo1.9b00466. https://doi.org/10.1021/acs.macromol.9b00466.

Wan, W.-M.; Baggett, A. W.; Cheng, F.; Lin, H.; Liu, S.-Y.; Jäkle, F. Synthesis by Free Radical Polymerization and Properties of BN-Polystyrene and BN-Poly(Vinylbiphenyl). Chem. Commun. 2016, 52, 13616-13619. https://doi.org/10.1039/C6CC07332H.

Thiedemann, B.; Gliese, P. J.; Hoffmann, J.; Lawrence, P. G.; Sonnichsen, F. D.; Staubitz, A. High Molecular Weight Poly(N-Methyl-B-Vinylazaborine)—a Semi-Inorganic B—N Polystyrene Analogue. Chem. Commun. 2017, 53, 7258-7261. https://doi.org/10.1039/C6CC08599G.

Ajellal, N.; Thomas, C. M.; Carpentier, J.-F. Functional Syndiotactic Poly(β-Hydroxyalkanoate)s via Stereoselective Ring-Opening Copolymerization of Rac-β-Butyrolactone and Rac-Allyl-β-Butyrolactone. J. Polym. Sci. Part A Polym. Chem. 2009, 47 (12), 3177-3189. https://doi.org/10.1002/pola.23418.

Yi, N.; Chen, T. T. D.; Unruangsri, J.; Zhu, Y.; Williams, C. K. Orthogonal Functionalization of Alternating Polyesters: Selective Patterning of (AB) n Sequences. Chem. Sci. 2019, 10.1039/C9SC03756J. https://doi.org/10.1039/C9SC03756J.

Sutandar, P.; Ahn, D. J.; Franses, E. I. FTIR ATR Analysis for Microstructure and Water Uptake in Poly(Methyl Methacrylate) Spin Cast and Langmuir-Blodgett Thin Films. Macromolecules 1994, 27 (25), 7316-7328. https://doi.org/10.1021/ma00103a013.

Hasha, D. L.; Hoffman, G. A.; Fouchea, H. A.; Nyquist, R. A. Infrared Study of β-Propiolactone in Various Solvent Systems and Other Lactones. Appl. Spectrosc. Vol. 45, Issue 5, pp. 860-867 1991, 45 (5), 860-867.

Otera, J. Transesterification. Chem. Rev. 1993, 93 (4), 1449-1470. https://doi.org/10.1021/cr00020a004.

Brown, H. C.; Keblys, K. A. Rates and Equilibria in the Reaction of γ-Butyrolactone with Alcohols. A Convenient Synthesis of 4-Hydroxybutyrates ¹. J. Org. Chem. 1966, 31 (2), 485-487. https://doi.org/10.1021/jo01340a031.

Krimm, S.; Liang, C. Y.; Sutherland, G. B. B. M. Infrared Spectra of High Polymers. V. Polyvinyl Alcohol. J. Polym. Sci. 1956, 22 (101), 227-247. https://doi.org/10.1002/pol.1956.1202210106.

Nagai, E.; Kuribayashi, S.; Shirai, M.; Ukita, M. Infrared Spectra of the Stereoisomers of Pentane-2,4-Diol as a Model for Polyvinyl Alcohol. J. Polym. Sci. 1959, 35 (128), 295-299. https://doi.org/10.1002/pol.1959.1203512833.

O'Keefe, B. J.; Hillmyer, M. A.; Tolman, W. B. Polymerization of Lactide and Related Cyclic Esters by Discrete Metal Complexes.J. Chem. Soc. Dalt. Trans. 2001, No. 15, 2215-2224. https://doi.org/10.1039/b104197p.

Jenkins, D. W.; Hudson, S. M. Review of Vinyl Graft Copolymerization Featuring Recent Advances toward Controlled Radical-Based Reactions and Illustrated with Chitin/Chitosan Trunk Polymers. Chem. Rev. 2001, 101 (11), 3245-3273. https://doi.org/10.1021/cr000257f.

Vidal, F.; Jäkle, F. Functional Polymeric Materials Based on Main-Group Elements. Angew. Chemie—Int. Ed. 2019, 58 (18), 5846-5870. https://doi.org/10.1002/anie.201810611.

Jäkle, F. Advances in the Synthesis of Organoborane Polymers for Optical, Electronic, and Sensory Applications. Chem. Rev. 2010, 110 (7), 3985-4022. https://doi.org/10.1021/cr100026f.

Messina, M. S.; Graefe, C. T.; Chong, P.; Ebrahim, O. M.; Pathuri, R. S.; Bernier, N. A.; Mills, H. A.; Rheingold, A. L.; Frontiera, R. R.; Maynard, H. D.; Spokoyny, A. M. Carborane RAFT Agents as Tunable and Functional Molecular Probes for Polymer Materials. Polym. Chem. 2019, 10 (13), 1660-1667. https://doi.org/10.1039/C9PY00199A.

Marro, E. A.; Klausen, R. S. Conjugated Polymers Inspired by Crystalline Silicon. Chem. Mater. 2019, 31 (7), 2202-2211. https://doi.org/10.1021/acs.chemmater.9b00131.

He, X.; Baumgartner, T. Conjugated Main-Group Polymers for Optoelectronics. RSC Adv. 2013, 3 (29), 11334. https://doi.org/10.1039/c3ra40286j.

Armarego, Wilfred L. F., C. C. L. L. Purification of Laboratory Chemicals, 5th ed.; Elsevier Science, 2003.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A method for preparing a compound of formula (I) or formula (II); 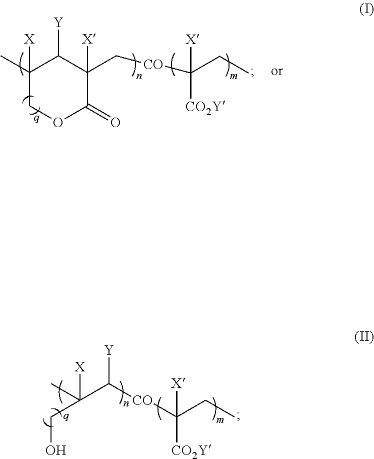
wherein:
each q is independently an integer selected from the group consisting of 0, 2, 3, 4, 5, 6, 7, and 8;
each n is independently an integer from 1 to 500;
each m is independently an integer from 1 to 1000;
X and X′ are each independently hydrogen or methyl;
Y is a hydrogen or an isobutyl group;
Y′ is selected from the group consisting of hydrogen, C₁-C₁₂ straightchain or branched alkyl, chloroalkyl, hydroxyalkyl, (dimethylamino)alkyl, (diethylamino)alkyl, cycloalkyl, phenyl, benzyl, and naphthyl; or a stereoisomer thereof;
the method comprising:
(a) contacting BN 2-vinylnaphthalene (BN2VN), or a derivative thereof, with methyl methacrylate (MMA), or a derivative thereof, in the presence of an initiator to form a first intermediate; and
(b) oxidizing the first intermediate to form a compound of formula (I) or formula (II).

2. The method of claim 1, wherein the BN 2-vinylnaphthalene (BN2VN), or a derivative thereof, has the following formula: 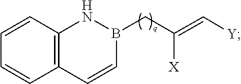
wherein:
X is a hydrogen or a methyl group;
Y is a hydrogen or an isobutyl group;
q is an integer selected from the group consisting of 0, 2, 3, 4, 5, 6, 7, and 8;
or a stereoisomer thereof.

3. The method of claim 2, wherein BN2VN or a derivative thereof is selected from the group consisting of 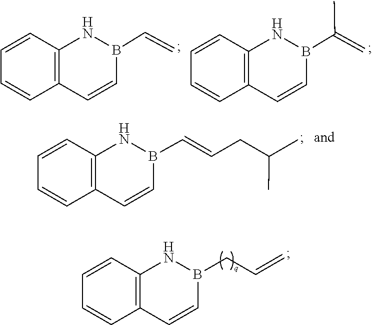
wherein q is an integer selected from the group consisting of 0, 2, 3, 4, 5, 6, 7, and 8 or a stereoisomer thereof.

4. The method of claim 1, wherein MMA or a derivative thereof has the following formula: 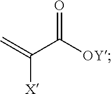
wherein:
X′ is a hydrogen or a methyl group;
Y′ is selected from the group consisting of hydrogen, C₁-C₁₂ straightchain or branched alkyl, chloroalkyl, hydroxyalkyl, (dimethylamino)alkyl, (diethylamino)alkyl, cycloalkyl, phenyl, benzyl, and naphthyl; or a stereoisomer thereof;
or a stereoisomer thereof.

5. The method of claim 1, wherein MMA or a derivative thereof is selected from the group consisting of: 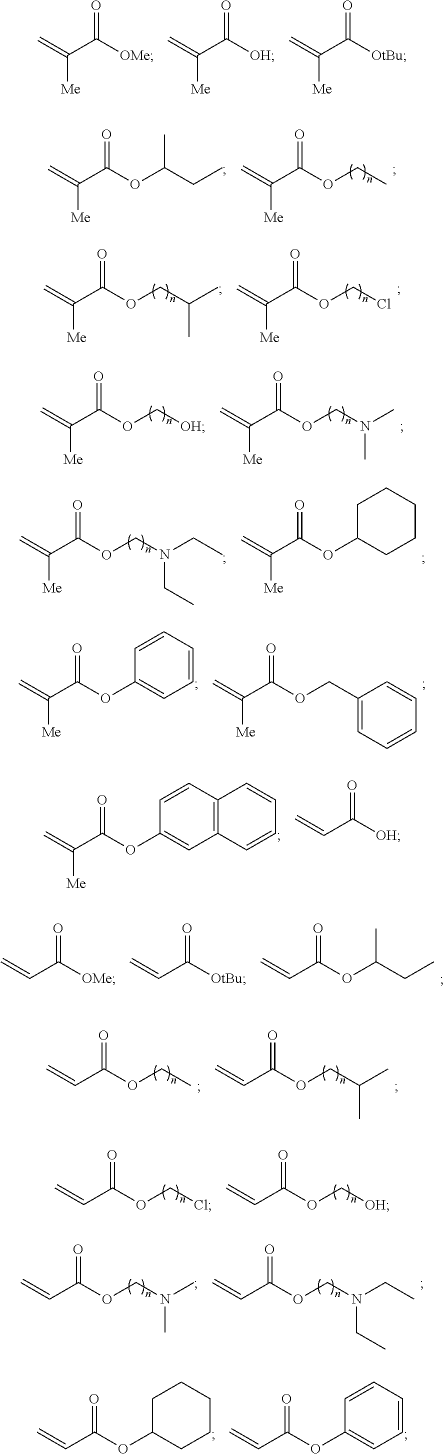 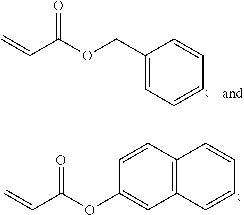
wherein n is an integer selected from the group consisting of 1, 2, 3, 4, 5, 6, 7, 8, 9, 10, 11, and 12, or a stereoisomer thereof.

6. The method of claim 1, comprising contacting BN2VN with MMA or tert-butyl methacrylate (tBMA).

7. The method of claim 1, wherein the initiator comprises 2,2-azobis(2-methylpropionitrile) (AIBN).

8. The method of claim 1, wherein the first intermediate comprises: 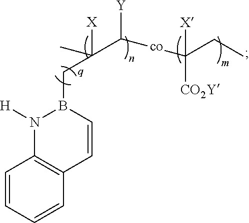
wherein:
q is an integer selected from the group consisting of 0, 2, 3, 4, 5, 6, 7, and 8;
n is an integer from 1 to 500;
m is an integer from 1 to 1000;
X and X′ are each independently hydrogen or methyl;
Y is a hydrogen or an isobutyl group;
Y′ is selected from the group consisting of hydrogen, C₁-C₁₂ straightchain or branched alkyl, chloroalkyl, hydroxyalkyl, (dimethylamino)alkyl, (diethylamino)alkyl, cycloalkyl, phenyl, benzyl, and naphthyl;
or a stereoisomer thereof.

9. The method of claim 8, wherein the first intermediate is:

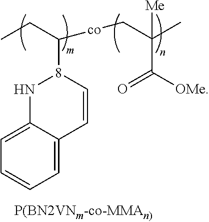

10. The method of claim 1, wherein the oxidizing step comprises contacting the first intermediate with Me₃NO.2H₂O and cyclopentyl methyl ether (CPME).

11. The method of claim 11, wherein the compound of formula (I) comprises: 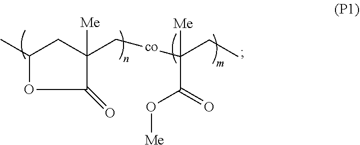
wherein n is an integer from 1 to 500 and m is an integer from 1 to 1000.

12. The method of claim 1, wherein the compound of formula (II) comprises:

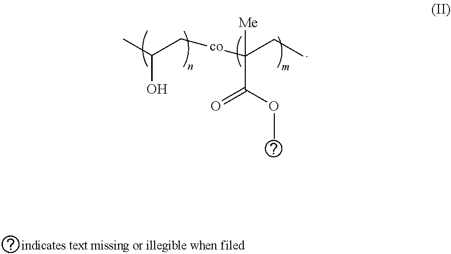

13. The method of claim 1, further comprising contacting the compound of formula (I): 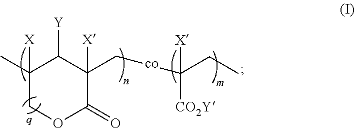
with a base to form a compound of formula (III): 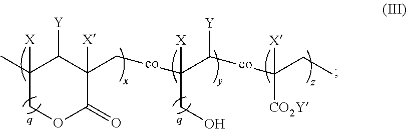
wherein:
q is an integer selected from the group consisting of 0, 2, 3, 4, 5, 6, 7, and 8;
x is an integer from 1 to 500;
y is an integer from 1 to 1000;
z is an integer from 1 to 1000;
X and X′ are each independently hydrogen or methyl;
Y is a hydrogen or an isobutyl group;
Y′ is selected from the group consisting of hydrogen, C₁-C₁₂ straightchain or branched alkyl, chloroalkyl, hydroxyalkyl, (dimethylamino)alkyl, (diethylamino)alkyl, cycloalkyl, phenyl, benzyl, and naphthyl; or a stereoisomer thereof.

14. The method of claim 13, wherein the base comprises NaOMe.

15. The method of claim 14, wherein the compound of formula (III) is: 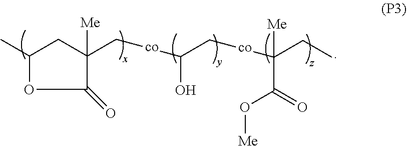
wherein x is an integer from 1 to 500, y is an integer from 1 to 1000 and z is an integer from 1 to 1000; or a stereoisomer thereof.

16. A compound of formula (III): 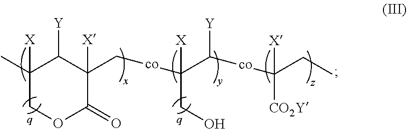
wherein:
q is an integer selected from the group consisting of 0, 2, 3, 4, 5, 6, 7, and 8;
x is an integer from 1 to 500;
y is an integer from 1 to 1000;
z is an integer from 1 to 1000;
X and X′ are each independently hydrogen or methyl;
Y is a hydrogen or an isobutyl group;
Y′ is selected from the group consisting of hydrogen, C₁-C₁₂ straightchain or branched alkyl, chloroalkyl, hydroxyalkyl, (dimethylamino)alkyl, (diethylamino)alkyl, cycloalkyl, phenyl, benzyl, and naphthyl; or a stereoisomer thereof.

17. The compound of claim 16, wherein the compound of formula (III) is: 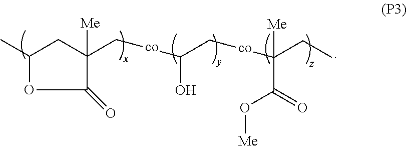
wherein x is an integer from 1 to 500, y is an integer from 1 to 1000 and z is an integer from 1 to 1000; or a stereoisomer thereof.

18. A compound of formula (I): 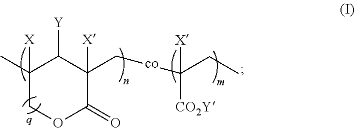
q is an integer selected from the group consisting of 0, 2, 3, 4, 5, 6, 7, and 8;
n is an integer from 1 to 500;
m is an integer from 1 to 1000;
X and X′ are each independently hydrogen or methyl;
Y is a hydrogen or an isobutyl group;
Y′ is selected from the group consisting of hydrogen, C₁-C₁₂ straightchain or branched alkyl, chloroalkyl, hydroxyalkyl, (dimethylamino)alkyl, (diethylamino)alkyl, cycloalkyl, phenyl, benzyl, and naphthyl; or a stereoisomer thereof.

19. A compound of formula (II): 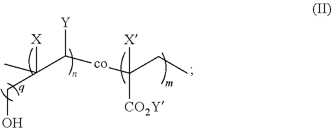
wherein:
q is an integer selected from the group consisting of 0, 2, 3, 4, 5, 6, 7, and 8;
n is an integer from 1 to 500;
m is an integer from 1 to 1000;
X and X′ are each independently hydrogen or methyl;
Y is a hydrogen or an isobutyl group;
Y′ is selected from the group consisting of hydrogen, C₁-C₁₂ straightchain or branched alkyl, chloroalkyl, hydroxyalkyl, (dimethylamino)alkyl, (diethylamino)alkyl, cycloalkyl, phenyl, benzyl, and naphthyl; or a stereoisomer thereof.

20. A compound of the formula: 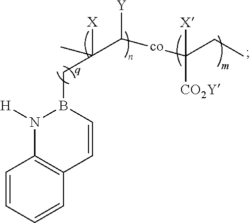
wherein:
q is an integer selected from the group consisting of 0, 2, 3, 4, 5, 6, 7, and 8;
n is an integer from 1 to 500;
m is an integer from 1 to 1000;
X and X′ are each independently hydrogen or methyl;
Y is a hydrogen or an isobutyl group;
Y′ is selected from the group consisting of hydrogen, C₁-C₁₂ straightchain or branched alkyl, chloroalkyl, hydroxyalkyl, (dimethylamino)alkyl, (diethylamino)alkyl, cycloalkyl, phenyl, benzyl, and naphthyl;
or a stereoisomer thereof.
